SEQUENCE LISTING (4 sequences)

SEQ ID NO: 1 - protein, 10 aa, synthetic construct
  SITE 10: note = Amidated residue
  SITE 1..10: note = All residues are linked via a Urea linkage
LELKPLELKA

SEQ ID NO: 2 - protein, 10 aa, synthetic construct
  SITE 10: note = Amidated residue
  SITE 1..10: note = All residues are linked via a Urea linkage
LELKALELKA

SEQ ID NO: 3 - protein, 10 aa, synthetic construct
  SITE 10: note = Amidated residue
  SITE 1..10: note = All residues are linked via a Urea linkage
LNLKPLNLKA

SEQ ID NO: 4 - protein, 10 aa, synthetic construct
  SITE 10: note = Amidated residue
  SITE 1..10: note = All residues are linked via a Urea linkage
LELKFLELKF

(19) United States
(12) Patent Application Publication
(10) Pub. No.: US 2026/0241346 A1
(43) Pub. Date: Aug. 20, 2026

(54) SYNTHETIC CHANNELS

(71) Applicants: NATIONAL UNIVERSITY OF SINGAPORE, Singapore (SG); UNIVERSITY OF BORDEAUX, Bordeaux (FR); CENTRE NATIONAL DE LA RECHERCHE SCIENTIFIQUE (CNRS), Paris (FR); THE UNIVERSITE DE MONTPELLIER, Montpellier (FR); ECOLE NATIONALE SUPERIEURE DE CHIMIE DE MONTPELLIER (ENSCM), Montpellier (FR); INSTITUT POLYTECHNIQUE DE BORDEAUX (BORDEAUX INP), Talence (FR)

(72) Inventors: Prakash Pallathadka KUMAR, Singapore (SG); Manjunatha Ramachandra Rao KINI, Singapore (SG); Chiranjit DUTTA, Singapore (SG); Pannaga KRISHNAMURTHY, Singapore (SG); Gilles GUICHARD, Talence (FR); Sung Hyun YOO, Talence (FR); Mihail BARBOIU, Montpellier (FR); Dandan SU, Montpellier (FR)

(73) Assignees: NATIONAL UNIVERSITY OF SINGAPORE, Singapore (SG); UNIVERSITY OF BORDEAUX, Bordeaux (FR); CENTRE NATIONAL DE LA RECHERCHE SCIENTIFIQUE (CNRS), Paris (FR); THE UNIVERSITE DE MONTPELLIER, Montpellier (FR); ECOLE NATIONALE SUPERIEURE DE CHIMIE DE MONTPELLIER (ENSCM), Montpellier (FR); INSTITUT POLYTECHNIQUE DE BORDEAUX (BORDEAUX INP), Talence (FR)

(21) Appl. No.: 19/162,639

(22) PCT Filed: Mar. 7, 2024
(86) PCT No.: PCT/SG2024/050136

§ 371 Date: Sep. 5, 2025

(30) Foreign Application Priority Data
Mar. 7, 2023 (SG) 10202300606Y

(51) Int. Cl. B01D 71/54; B01D 67/00; B01D 69/12; B01D 69/14; C08L 75/02

(52) U.S. Cl. CPC B01D 71/54; B01D 67/0006; B01D 69/1251; B01D 69/144; C08L 75/02

(57) ABSTRACT

Provided herein are oligourea foldamers comprising the sequence of Ac-L^{U}E^{U}L^{U}K^{U}P^{U}L^{U}E^{U}L^{U}K^{U}A^{U}-NH₂ (SEQ ID NO: 1) or Ac-L^{U}E^{U}L^{U}K^{U}A^{U}L^{U}E^{U}L^{U}K^{U}A^{U}-NH₂ (SEQ ID NO: 2), and permeable membranes comprising thereof. Also provided herein is a method of purifying water using the permeable membranes.

### CROSS-REFERENCE TO RELATED APPLICATIONS

This application is a National Stage Application of International Application No. PCT/SG2024/050136, filed Mar. 7, 2024, which claims the benefit of priority of Singapore Application No. 10202300606Y, filed on 7 Mar. 2023, the entire contents of each of which are incorporated herein by reference in their entireties.

### SEQUENCE LISTING

The instant application contains a Sequence Listing which has been submitted electronically in XML format and is hereby incorporated by reference in its entirety. Said XML copy, created on Nov. 17, 2025, is named 270535_000002_SL.xml and is 7,555 bytes in size.

### FIELD OF THE INVENTION

The present invention relates generally to the fields of bioengineering, material science and chemistry. In particular, the present invention relates to synthetic channels and uses thereof in water purification.

### BACKGROUND

Water scarcity is a global problem. Reverse osmosis is a costly and energetic water purification technology. Biomimetic membranes embedded with aquaporin (AQP) or artificial water channels (AWC) had been developed to meet the industry needs. Although aquaporin exhibits high water permeability, its long-term stability is a limiting factor.

Fresh water scarcity currently affects over 4 billion people worldwide and is a growing challenge faced by humanity. High population, industrialization, deforestation and climate change led to depletion and contamination of natural water resources, all of which increase the demand for fresh water. Fresh water sources are becoming scarce and competing demands such as industrial needs, domestic use for the increasing population will make water a scarce commodity in the future. The effects of climate change will exacerbate this problem. Approximately half of the world population suffers from water scarcity or lack of clean drinking water.

Currently, reverse osmosis (RO) membrane and membrane distillation technologies are used to produce ~100 million tons of desalinated water per day from seawater. However, the high energy consumption and overall cost of the existing technologies necessitate the search for better alternatives. In this regard, the aquaporins (AQPs) have been proposed as active components for the fabrication of desalination reverse osmosis bio-assisted membranes. Aquaporins are transmembrane proteins that allow high water permeability (about 10⁹ H₂O s⁻¹) across lipid membranes, while completely rejecting ions and protons. The main structural feature of the aquaporin hydrophobic interior is a narrow 3 Å diameter pore, composed of a key asparagine-proline-alanine (NPA) motif, which enables the transport of water molecules in a single file. Unfortunately, development of aquaporin-based membranes is limited by the long-term protein stability issues under harsh pressure and salinity reverse osmosis (RO) conditions. In addition, designing artificial water channels to achieve high water permeation with salt rejection is a challenge. Thus, there is a need for technologies with improved properties for water purification.

### SUMMARY

In one aspect, the present disclosure refers to an oligourea foldamer comprising one or more sequences selected from the group consisting of SEQ ID NO: 1 (Ac-L^{U}E^{U}L^{U}K^{U}P^{U}L^{U}E^{U}L^{U}K^{U}A^{U}-NH₂) and SEQ ID NO: 2 (Ac-L^{U}E^{U}L^{U}K^{U}A^{U}L^{U}E^{U}L^{U}K^{U}A^{U}-NH₂).

In another aspect, the present disclosure refers to a compound comprising oligourea foldamers as disclosed herein.

In yet another aspect, the present disclosure refers to a permeable membrane comprising the oligourea foldamer as disclosed herein or the compound as disclosed herein.

In a further aspect, the present disclosure refers to a method of purifying water, the method comprising allowing water to pass through a filtration device comprising the permeable membrane as disclosed herein.

### BRIEF DESCRIPTION OF THE DRAWINGS

The invention will be better understood with reference to the detailed description when considered in conjunction with the non-limiting examples and the accompanying drawings, in which:

FIG. 1 shows an overview of the molecular design and biophysical characterization of oligourea foldamers. FIG. 1A shows helical-wheel representations of designed H2 variants showing side-chain distribution of oligourea residues in pentad. Polar and charged residues, and uncharged residues are depicted as filled and unfilled circles, respectively. FIG. 1B shows the sequences of synthesized amphipathic oligourea foldamers H2OC1, H2OC2, H2OC3 and H2OC4. Highlighted residues represent the point mutation to H2OC1. FIG. 1C shows circular dichroism (CD) spectra of oligourea foldamers show a peak at ~202 nm indicating their helical conformation. FIG. 1D shows CD spectra of H2OC2 in water exhibit concentration-dependent increase of molar ellipticity at ~202 nm. FIG. 1E and FIG. 1F show negative-stained transmission electron micrographs of H2OC1 (FIG. 1E) and H2OC2 (FIG. 1F) revealed self-assembled morphologies at 200 μM in 10 mM HEPES buffer, pH 7.0. They showed fibre-like networks packed in large, knotted bundles (H2OC2, diameter ranging from 12.4 to 40.0 nm) and distinct fibres (H2OC1, diameter 5.5±0.6 nm). FIG. 1G and FIG. 1H show electrospray ionization (ESI) mass spectrometry profiles of H2OCl (FIG. 1G) and H2OC2 (FIG. 1H), respectively. The ESI spectra reveal distribution of heterogeneous multimeric species of oligoureas. The isotopic peak at m/z value of 1856.76 of H2OC1 indicates pentameric species ([5]4+). Other isotopic peaks of multimers are also identified. Figure discloses SEQ ID NOS 1-4, respectively, in order of appearance.

FIG. 2 shows an overview of biophysical properties of foldamer insertion into lipid vesicles. FIG. 2A shows 31P static solid-state NMR experiments performed at 303K on PC/PS control vesicles and PC/PS vesicles incorporating H2OC1 and H2OC2. FIG. 2B shows 2H static solid-state NMR experiments performed at 303K. FIG. 2C shows a line graph depicting thermal variation of the first spectral moment M1 of PC lipids as measured by 2H solid state NMR. FIG. 2D shows a graph depicting C-²H order parameter as a function of labelled lipid carbon position. FIG. 2E shows a single particle cryo-EM image of self-assembled channels of H2OC1 in a liposome. The top left panel shows a low magnification image. Arrows point to three channels in the enlarged view (i) the boxed area (ii) showing an array of channels, see FIG. 2G. FIG. 2F shows a single particle cryo-EM image of control liposome without H2OC1. The magnified image shows a contiguous membrane without channels (iii). FIG. 2G shows a magnified image showing the array of channels (arrows) in the lipid bilayer. FIG. 2H shows two-dimensional (2D) average images of H2OC1 EM particles (top). Two representative channels are outlined with dashed boxes. 2D averages of EM particle images of control liposomes (bottom); no obvious channel density was observed. FIG. 2I shows an image indicating the size of each channel, the distance between two neighbouring channels, and the membrane are indicated. The outer diameter of individual channels is 26 Å, compared to 29 Å in the crystal structure of H2OC1. The distance between two adjacent channels is 37 Å.

FIG. 3 shows the results of measurements of water and ion transport through oligourea foldamers. FIG. 3A Schematic representation of water permeability measurement through foldamer channels in presence of phosphatidylcholine/phosphatidylserine (PC/PS) vesicles while mixing with hypertonic osmolyte (600 mM sucrose). FIG. 3B shows the results of stopped-flow analysis of oligourea foldamers, which shows water permeation through foldamer channels in PC/PS (4:1) vesicles. FIG. 3C shows light scattering traces of H2OC2 embedded in PC/PS vesicles with different molar ratio. This shows an increasing water permeability with increased channel concentration while mixing with hypertonic osmolyte (600 mM sucrose). Curves were fitted with stretched function “y=c+a exp (−Kx^{b})” to obtain exponential coefficients (K). FIG. 3D shows results indicating that water permeability through H2OC2 channel measured at different channel densities exhibited a jump in permeability when lipid/channel molar ratio reached 100:1 to 50:1. This indicates a possible cooperativity. FIG. 3E shows a schematic representation of HPTS based fluorescence assay under high ionic gradients (100 mM NaCl and KCl). HPTS-8-hydroxypyrene-1,3,6-trisulfonic acid. FIG. 3F and FIG. 3G shows salt rejections by H2OC1 and H2OC2 with respect to natural ionophore gA and foldamers H2OC3 and H2OC4 as evidenced from curve. gA=gramicidin A. FIG. 3H shows a schematic representation of chloride-selective ion transport by SPQ dye based on fluorescence assay. FIG. 3I shows results indicating chloride-selective ion transport. Results obtained by SPQ-based quenching assays show rejection of chloride ion by H2OC1, H2OC2 and H2OC3. Concentration-dependent fluorescence quenching observed upon addition of H2OC4 indicating chloride transport by foldamer H2OC4.

FIG. 4 shows images of the crystal structure revealing quaternary structure of foldamer H2OC1. FIG. 4A is an image of the crystal structure of H2OC1 showing a helical conformation of the monomer with a distinct hydrophobic and hydrophilic surfaces. FIG. 4B is an image of crystal packing showing two distinct channels (FIGS. 4A and 4B). In this structure, channel B is formed in the interspace of four channel A assemblies. Both channels are packed through hydrophobic interactions of exterior surfaces. In the channel assembly, eight monomeric oligourea helices per turn are packed laterally. The neighbouring helices are in an antiparallel orientation within the superhelical structure. Interior of both channels are composed of hydrophilic residues, creating a charged nanopore, while hydrophobic residues line the exterior. FIG. 4C shows images of the crystal structure with water molecules that are H-bonded with the foldamer, shown as spheres, in the pores of channels A and B. Water molecules that do not form any H-bonding with foldamer helices are shown as well. Only selected water molecules are displayed. FIG. 4D shows water molecules in the pore form a H-bonding network with charged residues, Glu^{U} and Lys^{U}. Hydrogen bonds show O—O and N—O distances of 2.7 and 3.6 Å, respectively. Images were created using PyMOL.

FIG. 5 shows data of molecular dynamics simulations of H2OC1 oligourea channel in POPC: POPS (4:1 ratio) lipid bilayer. FIG. 5A shows that the H2OCl oligourea channel composed of 8 helical and 16 kinked helices embedded in lipid bilayer together with simulation snapshots: i) prior to any simulation, ii) after 200 ns of equilibration with position restraints on helical foldamer alpha carbon atoms, iii) after 600 ns of the production run without any restraints. Surface representation of the helices are shown in dark grey. The 16 kinked helices are shown in light grey stick representation. Spheres correspond to phospholipid head groups. Water, ions and lipid headgroups were omitted for figure clarity. FIG. 5B shows the control system of the H2OC1 oligourea channel composed of 8 helices alone together with simulation snapshots: iv) after 200 ns of equilibration with position restraints on alpha carbon atoms, v) after 600 ns of the production run without any restraints. FIG. 5C shows the root mean-square-deviation (RMSD) of alpha carbon atoms from 8 helices calculated with respect to the experimental structure. FIG. 5D and FIG. 5E show the number of water molecules (FIG. 5D) and number of ions (FIG. 5E) passing through both channel types (shown in FIG. 5A and FIG. 5B) over the last 200 ns of the trajectory are shown. FIG. 5F and FIG. 5G show the average channel radius profile across the membrane normal (the two radius profile tracings in each represent the standard deviation limits) together with snapshots of the averaged density of the solvent within the pore (light grey, traversing the membrane) are shown for the two cases, namely, with (FIG. 5(F)) and without kinked (FIG. 5(G)) helices. The radius profile as well as solvent density were averaged over the last 200 ns of the production run.

FIG. 6 shows graphs depicting the solid phase synthesis of oligourea H2OC1. FIG. 6A and FIG. 6B show the chemical structure and analytical HPLC profile of purified H2OC1 foldamer (tR=5.85 min). FIG. 6C shows the electrospray ionization mass spectrum of H2OC1 foldamer (pure). Expected M.W. 1484.88 Da; observed M.W. 1485.25 Da ([M+H]⁺), 743.19 Da ([M+2H]²⁺), 495.82 Da ([M+3H]³⁺). Figure discloses SEQ ID NO: 1.

FIG. 7 shows graphs depicting the solid phase synthesis of oligourea H2OC2. FIG. 7A and FIG. 7B show the chemical structure and analytical HPLC profile of purified H2OC2 foldamer (tR=6.39 min). FIG. 7C shows the electrospray ionization mass spectrum of H2OC2 foldamer. Expected M.W. 1458.84 Da; observed M.W. 1459.99 Da ([M+H]⁺), 730.00 Da ([M+2H]²⁺), 486.99 Da ([M+3H]³⁺). Figure discloses SEQ ID NO: 2.

FIG. 8 shows graphs depicting the solid phase synthesis of oligourea H2OC3. FIG. 8A shows the chemical structure of H2OC3 foldamer. FIG. 8B shows ESI-MS spectrum of H2OC3 foldamer. Expected M.W. 1454.00 Da; observed M.W. 1455.13 Da ([M+H]⁺), 728.08 Da ([M+2H]²⁺), 485.73 Da ([M+3H]³⁺). (Inset) analytical HPLC profile of purified H2OC3 foldamer is shown ((R=5.77 min). Figure discloses SEQ ID NO: 3.

FIG. 9 shows graphs depicting the solid phase synthesis of oligourea H2OC4. FIG. 9A and FIG. 9B show the chemical structure and analytical HPLC profile of purified H2OC4 foldamer ((R=7.54 min). FIG. 9C shows the electrospray ionization mass spectrum of H2OC4 foldamer. Expected M.W. 1611.03 Da; observed M.W. 1612.04 Da ([M+H]⁺), 806.04 Da ([M+2H]²⁺), 537.69 Da ([M+3H]³⁺). Figure discloses SEQ ID NO: 4.

FIG. 10 shows the results of a variable-concentration CD analysis of foldamers. Foldamer H2OC1 (FIG. 10A), H2OC3 (FIG. 10B) and H2OC4 (FIG. 10C) are shown to exhibit concentration-dependent increase of molar ellipticity at 202 nm in pure water. FIG. 10D shows the results of a CD analysis of H2OC1 and H2OC2 at pH 4.4 exhibiting helical conformation.

FIG. 11 shows the results of the biophysical characterization of H2OC3 and H2OC4 foldamers. FIG. 11A shows a TEM image of H2OC3 showing spherical morphology with 24.3±8.7 nm in diameter. FIG. 11B shows the native electrospray ionization (ESI) mass spectrometry profile of H2OC3 showing a major peak distribution at 1819.27 indicating pentameric [54+] species. FIG. 11C show a TEM image of H2OC4 showing long filament like self-assembly with a width of 132.1+24.4 nm. Inset exhibiting close view of a discrete filament.

FIG. 12 shows histograms depicting the hydrodynamic radius of foldamer embedded PC/PS (4:1) lipid vesicles. Histogram plot of foldamers embedded in lipid vesicles was determined by dynamic light scattering (DLS).

FIG. 13 shows the stopped flow data of foldamer embedded PC/PS (4:1) lipid vesicles. Light scattering traces of H2OC1, H2OC2, H2OC3, H2OC4 and gA embedded in PC/PS (4:1) vesicles with molar ratio 1:100 (foldamer: lipid) show an increasing water permeability compared to blank (without foldamer) while mixing with a hypertonic osmolyte (600 mM sucrose). Curves were fitted with stretched function y=c+a exp (−Kx^{b}) to obtain exponential coefficients (K).

FIG. 14 shows a histogram depicting the water permeability of H2OC2 at different PC/PS molar ratio. H2OC2. shows increased water permeability until PC/PS molar ratio reach 4:1 followed by decreasing water permeability with increased PS concentration.

FIG. 15 shows a histogram depicting the water permeability of H2OC2 in presence of different osmolytes. H2OC2 showed water permeability in presence of sucrose, glycine and glucose in PC/PS (4:1) lipid vesicles.

FIG. 16 shows graphs depicting data indicating that foldamers reject divalent ion transport. Results of HPTS assays show that H2OC1 and H2OC2 did not transport divalent ions Mg²⁺ and Ca²⁺ (MgCl₂ and CaCl₂)) in PC/PS (4:1) lipid vesicles.

FIG. 17 shows the results of the analysis of proton transport of H2OC1 and H2OC2 by patch-clamp technique in PC/PS (4:1) lipid. Single channel current traces and I-V plots of H2OC2 (FIG. 17A) and H2OC1 (FIG. 17B) recorded in symmetrical solutions (cis chamber=trans chamber=0.1 M HCl solution) are shown.

FIG. 18 shows the results of the analysis of proton transport of H2OC1 and H2OC2 by patch-clamp technique in DOPC lipid. Single channel current traces and I-V plots of H2OC2 (FIG. 18A) and H2OC1 (FIG. 18B) recorded in symmetrical solutions (cis chamber=trans chamber=0.1 M HCl solution) are shown.

FIG. 19 shows the results of ion transport analysis of H2OC1 by patch-clamp technique in DOPC lipid. Single channel current traces and I-V plots of H2OC1 recorded in (FIG. 19A) symmetrical solutions (cis chamber=trans chamber=1 M KCl solution) and (FIG. 19B) unsymmetrical solutions (cis chamber=1 M KCl solution, trans chamber=1 M NaCl solution) in DOPC lipid are shown.

FIG. 20 shows the results of ion transport analysis of H2OC2 by patch-clamp technique in DOPC lipid. Single channel current traces and I-V plots of H2OC2 recorded in (FIG. 20A) symmetrical solutions (cis chamber=trans chamber=1 M KCl solution) and (FIG. 20B) unsymmetrical solutions (cis chamber=1 M KCl solution, trans chamber=1 M NaCl solution) using DOPC lipid are shown.

FIG. 21 shows the results of ion transport analysis of H2OC1 and H2OC2 by patch-clamp technique in PC/PS (4:1) lipid. Single channel current traces and I-V plots of (FIG. 21A) H2OC1 and (FIG. 21B) H2OC2 recorded in symmetrical solution (cis chamber=trans chamber=1 M KCl) using PC/PS (4:1) lipid are shown.

FIG. 22 shows images depicting the structural comparison of H2OC1 and H2 crystal structures. Dashed lines showing intramolecular H-bonding. Nitrogen atoms and oxygen atoms are coloured blue and red, respectively. All canonical helical intramolecular H-bonds are observed except at the C-terminal region of H2OC1 helices.

FIG. 23 shows crystal structures showing water filled channels in H2OC1. Crystal form shown with all water molecules (top) and selected water molecules only (bottom). Water molecules are shown as spheres. Carbon, nitrogen and oxygen atoms are coloured white, blue and red, respectively.

FIG. 24 shows crystal structures showing water wires in the H2OC1 channel. A pattern of water wires observed in the superhelix of channel A and channel B, indicated by ball and stick model. Water molecules are shown as red spheres. Water molecules that do not form any H-bonds with foldamer helices are represented as pink spheres. Water-water H-bonding marked with yellow dashed lines. Only selected water molecules shown here. Carbon, nitrogen and oxygen atoms are coloured white, blue and red, respectively.

FIG. 25 shows stick-and-ball as well as ribbon 3D models of a H2OC1 channel with kinked helix. (top, left) A distorted helix filling the void space in between the neighbouring channels highlighted with magenta colour in H2OC1. It has a kink region near Pro^{U} and Lys^{U}. (top, right) the distorted helix binds to the channels. The distorted helix is shown in the ribbon model and channels in the stick model. (bottom, right) channel structure shown in surface model.

FIG. 26 shows images depicting the H2OC1 and H2OC2 nanostructures. Results of TEM analysis of H2OC1 (FIG. 26A) and H2OC2 (FIG. 26B) under conditions (10 mM HEPES pH 7.5, 25% isopropanol) similar to those of crystallization are shown. Both show long fibres with different fibre widths of 20.674±2.53 and 9.31±0.52 nm, respectively. Inset images shows that H2OC2 forms a fibre bundle, whereas H2OC1 shows a distinct fibre assembly with a larger diameter.

FIG. 27 shows line graphs showing molecular dynamics simulations of H2OC1 oligourea channel in POPC: POPS (4:1 ratio) lipid bilayer. FIG. 27A shows the permeation pathway length (membrane normal axis) over last 200 ns of the simulation time, while FIG. 27B shows the number hydrogen bonds between water molecules and side chains of two glutamic acids of H2OC1 helical oligoureas.

FIG. 28 shows a scheme of the solid-phase synthesis and cleavage of the oligourea foldamers. Solid phase synthesis of oligourea foldamers was performed in a microwave reactor (CEM Discover) using the protocol described earlier (Douat-Casassus et al. Organic Letters 2012 and Collie et al. Nat. Chem., 2015). NovaPEG Rink amide resin (shown as spheres in the image) was used for the synthesis.

FIG. 29 shows a schematic overview of the subject matter described in the present disclosure.

FIG. 30 shows images obtained from the single-particle cryo-EM analysis of H2OC1 reconstituted in liposome. FIG. 30A shows a representative cryo-EM image of H2OC1 sample with several particles marked by circles. FIG. 30B shows an image processing flowchart of H2OC1. FIG. 30C shows images of 2D averages of cryo-EM particle images of H2OC1. The box dimension is 200 Å. FIG. 30D shows a representative cryo-EM image of empty liposome sample with several particles marked by circles. FIG. 30E shows an image processing flowchart of empty liposome control. FIG. 30F shows an image of 2D averages of cryo-EM particle images of the control. The box dimension is 200 Å.

### DETAILED DESCRIPTION

Biomimetic membranes incorporating artificial water channels (AWC) are being developed for industrial water purification. Achieving high water permeation with salt rejection remains a challenge to be overcome while designing artificial water channels. Natural porins are the perfect examples of selective water transport through the cell membrane.

There has yet to be an attempt to create artificial water channels from sequence-defined proteinomimetic foldamers that are used as scaffolds that self-assemble into precise quaternary nanostructures with intrinsic porosity (i.e., self-assembled foldamer-based porin-like channels). N,N′-linked oligoureas are a class of synthetic peptidomimetic foldamers that have been demonstrated to form well-defined helical structures in both organic and aqueous environment akin to regular peptide helices.22 Amphipathic sequences with a patch of hydrophobic side chains at the surface of the helix have been shown to self-assemble into various quaternary structures including nanotubular structures. These oligourea sequences were synthesized using solid phase techniques akin to peptide synthesis, from enantiopure activated monomers prepared from amino acid derivatives (building blocks [BBs]). The building blocks were protected on one side as azides and activated at the other extremity as succinimidyl carbamates (e.g., N₃-Leu^{U}-OSu). In contrast to natural peptides, these foldamers are substantially more resistant to proteolytic degradation due to their oligourea (i.e., non amide) backbone. These different properties make them potential candidates for synthesizing artificial water channels. Disclosed herein is the design and synthesis of amphiphilic oligourea foldamers, which are able to form transmembrane channels exhibiting high water permeability rejecting all ions. The non-natural oligomers described herein form tunable helical scaffolds self-assembled in Porin-like nanostructures. The state of oligomerization was investigated by mass spectrometry (MS) and transmission electron microscopy (TEM). The molecular insertion into lipid vesicles was investigated by solid-state NMR spectroscopy. Their water and ion permeability properties were further characterised in lipid vesicles. Also, their three-dimensional structures elucidated by X-ray crystallography is described herein. The high water permeability coupled with resistance to proteolytic degradation makes these synthetic foldamers candidates for industrial water purification applications.

Oligourea foldamers form predictable, helical structures that can be used to create similar biomimetic porin-like architectures. Disclosed herein is the synthesis of amphipathic, helical oligourea foldamers that self-assemble to generate artificial channel-type nanostructures. Two of these foldamers (H2OC1, H2OC2) allow water permeability of up to 88.7 μm/s across lipid membranes while providing almost total salt rejection. Solid-state NMR experiments suggest proper insertion of foldamers into lipid vesicles, without perturbing the lipid phase, thermotropism and internal dynamics.

The H2OC1 crystal structure shows that oligourea helices pack together by hydrophobic and salt bridge interactions to build two channel-like assemblies. These channels differ in their hydrogen bonding patterns and result in hydrophilic pores of diameter 4.8 and 6.4 Å, respectively. Molecular dynamics simulation supports the experimental data on transport properties and indicates that H2OC1 can form a stable channel in lipid membranes. The selectivity of water and ions through foldamer assemblies is regulated at the sequence level. Ease of design, synthesis, purification, proteolytic stability, and microbial resistance of oligourea foldamers are added advantages. Thus, the information obtained and disclosed herein has been used to develop novel artificial water channels for water purification applications.

In summary, the present disclosure refers to the design of synthetic, self-assembling, helical oligourea foldamers that form artificial water channels. Results of solid-state NMR experiments and molecular dynamics simulation indicate proper insertion of foldamers into lipid vesicles, without perturbations of the lipid phase, thermotropism and internal dynamics. Furthermore, oligomerization of the amphipathic foldamers is shown to lead to channel-type nanostructures in lipid membranes with selective, high water transport and ion rejection. X-ray crystal structure analysis shows a narrow (4.8 Å) hydrophilic pore in the superhelical assembly of a selected water transporting oligourea foldamer. Short helical amphipathic oligourea foldamers were designed with distinct hydrophobic and hydrophilic faces. Two of the foldamers (H2OC1 and H2OC2) obtained by solid phase synthesis self-assembled into channel-type nanostructures that show efficient water permeability across lipid membranes, while rejecting ions. A self-assembled quaternary structure with two superhelical scaffolds results in the formation of 4.8 and 6.4 Å inner pores that were observed in the crystal packing of H2OC1. Both pores have hydrophilic interior and hydrophobic exterior surfaces. The findings disclosed herein demonstrate the channel forming ability of oligourea foldamers in lipid bilayers and the use of such artificial water channels in water purification applications.

Thus, disclosed herein are artificial water channels obtained using sequence-defined proteinomimetic foldamers that are used as scaffolds that self-assemble into precise quaternary nanostructures with intrinsic porosity (i.e. self-assembled foldamer-based porin-like channels).

N,N′-linked oligoureas are a class of synthetic peptidomimetic foldamers which have been demonstrated to form well-defined helical structures in both organic and aqueous environment akin to regular peptide helices.

Amphipathic sequences with a patch of hydrophobic side chains at the surface of the helix have been shown to self-assemble into various quaternary structures including nanotubular structures. These oligourea sequences were synthesized using, for example, solid-phase techniques akin to peptide synthesis, from enantiopure activated monomers prepared from amino acid derivatives (building blocks, BB). The building blocks are protected on one side as azides and activated at the other extremity as succinimidyl carbamates (e.g., N₃-Leu^{U}-OSu). In contrast to natural peptides, these foldamers are more resistant to proteolytic degradation due to their oligourea (i.e. non amide) backbone. These different properties make them candidates for synthesizing artificial water channels.

Disclosed herein is the design and synthesis of amphiphilic oligourea foldamers, which are able to form transmembrane channels exhibiting high water permeability rejecting all ions. These non-natural oligomers are shown herein to form tuneable helical scaffolds self-assembled in porin-like nanostructures. The state of oligomerization was investigated by mass spectrometry and transmission electron microscopy (TEM). The molecular insertion into lipid vesicles was investigated by solid-state NMR spectroscopy. Their water and ion permeability properties were further characterised in lipid vesicles. Also, shown herein are their three-dimensional structures elucidated by X-ray crystallography. The high-water permeability coupled with resistance to proteolytic degradation makes these novel synthetic foldamers possible candidates for industrial water purification applications. The designed and synthesized helical amphipathic oligourea foldamers can be used to generate artificial porins, as a new class of artificial water channels. The chemical synthesis can be scaled up with sequence-based tunability of their properties. They self-assemble to form channel-type structures that exhibit selective water permeability across lipid bilayers. The crystal packing of one foldamer shows a superhelical assembly resulting in the formation of a porin-like superstructure with a hydrophilic pore of 4.8 Å diameter. The resistance of oligoureas to proteolytic degradation could offer long-term stability indicating their suitability for water purification.

### Design and Synthesis

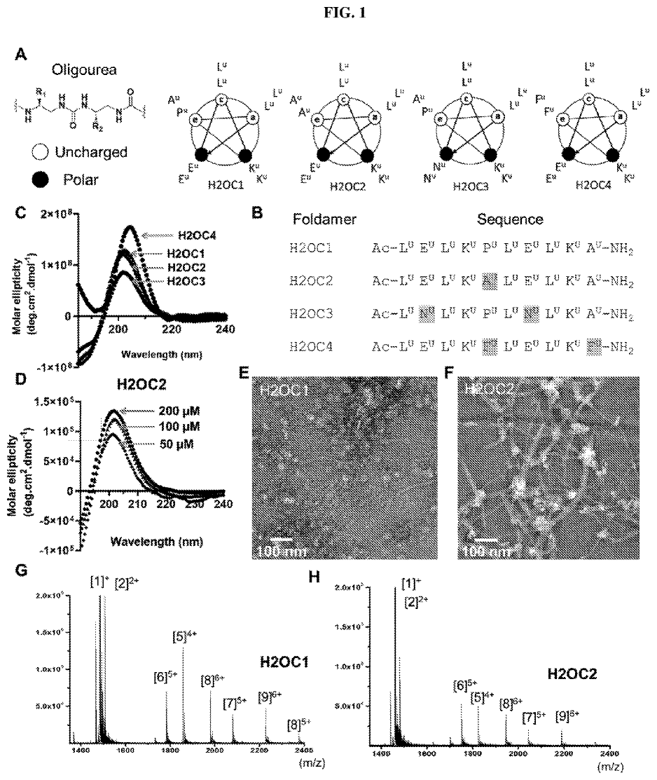

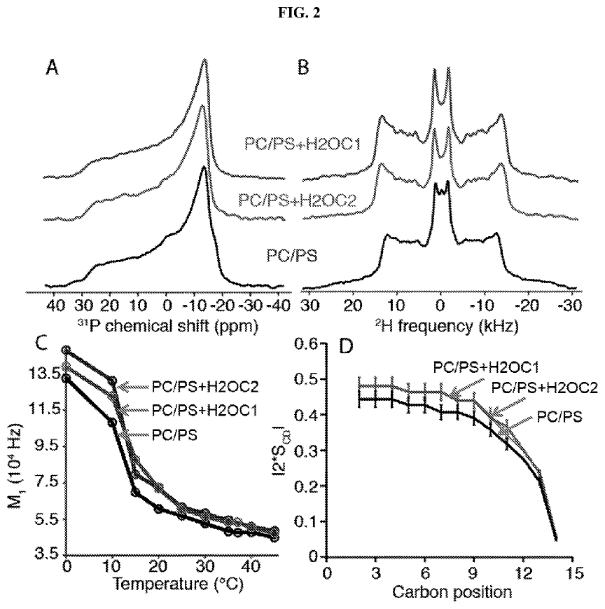

To design transmembrane water channels, H2OC1-H2OC4 scaffolds were designed based on a 10-mer showing an extended superhelical structure with two right-handed intertwined superhelices that form a channel in aqueous conditions with hydrophilic interior and a pore diameter of about 17 Å due to its global amphipathicity. The oligourea sequence, composed of two pentad repeats, has been designed to form an amphipathic helix with an extended hydrophobic face using the following principles. At positions ‘a’ and ‘c’: four leucine-type urea residues (Leu^{U}) (two in each pentad repeat); at position ‘e’: proline-type (Pro^{U}) residue in the first pentad and alanine-type (Ala^{U}) in the second pentad (FIG. 1A). These hydrophobic residues at the exterior surface assist in forming a dense and precise packing during self-assembly of H2. Additionally, the side chains of four charged residues (two glutamate-type side chains (Glu^{U}) at position ‘b’ and two lysine-type side chains (Lys^{U}) at position ‘d’) point into the lumen and form a highly charged interior of the channel. Without being bound by theory, it is thought that the electrostatic interactions and salt-bridges play a major role in the formation of intricate H-bonding network among proximal and distal oligourea residues and contribute to stabilize the overall packing.

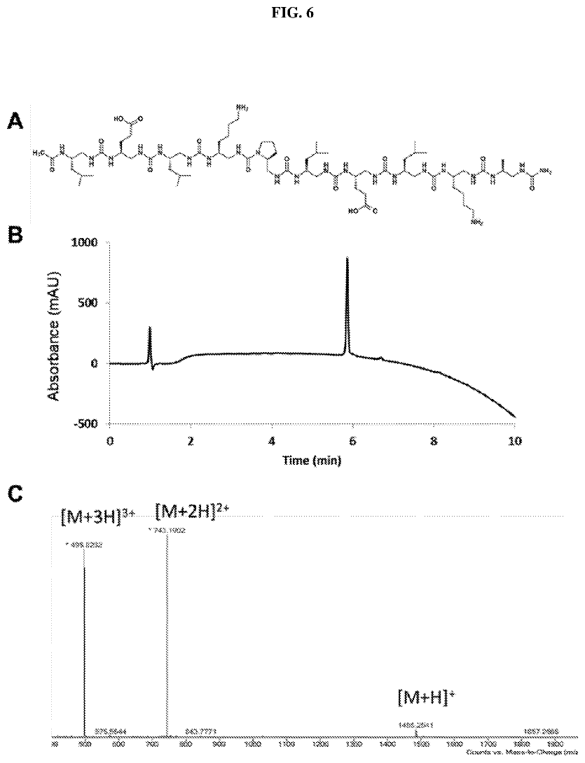

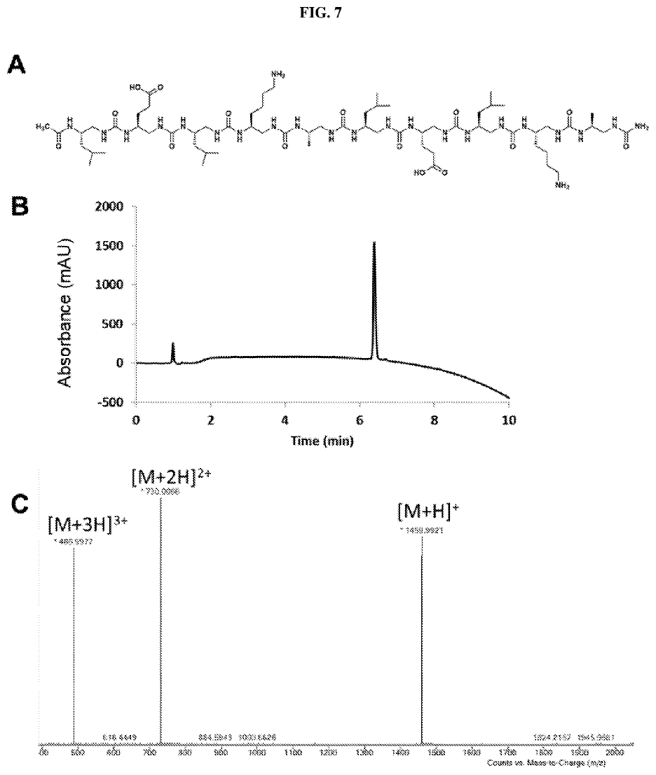

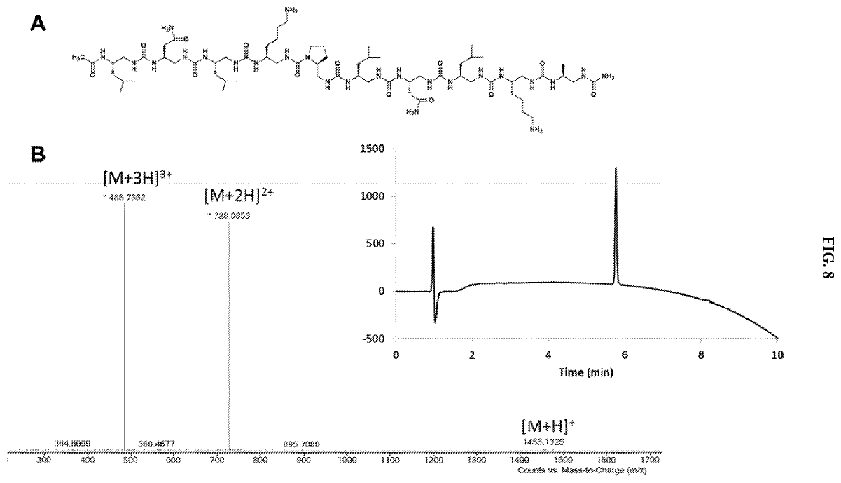

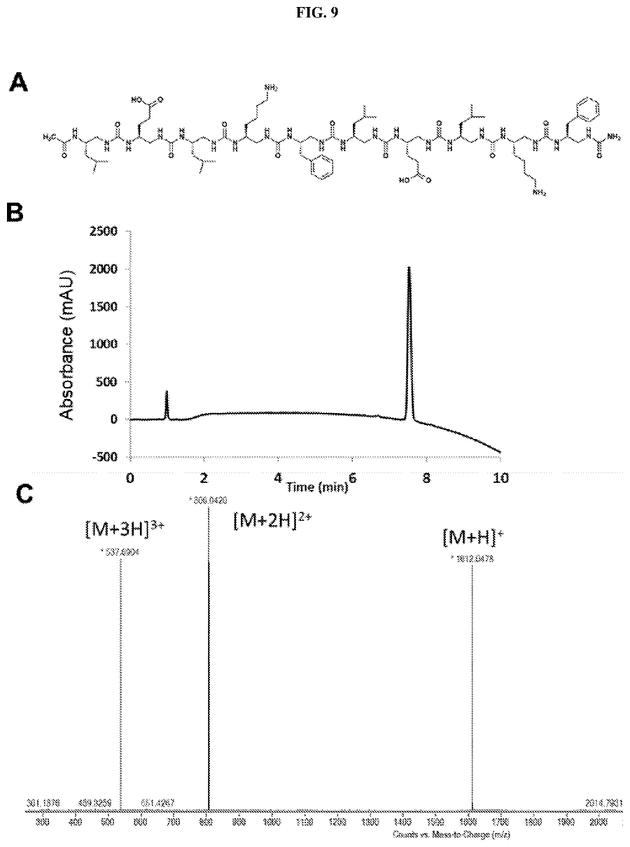

A series of close H2 analogues were designed and synthesised, and structural and functional analyses were performed (FIG. 1, FIGS. 6 to 9 and Table 2). In the first analogue, H2OC1, the N-terminal isopropyl group was replaced by an acetyl group and the C-terminal methyl urea was replaced by a simple urea termination to reduce the hydrophobicity (FIGS. 1A-1B). To understand the local constraining effect of Pro^{U}, a second analogue H2OC2 was prepared in which Pro^{U} is replaced with Ala^{U} at position ‘e’ (FIG. 1A; 1B). It is shown that Pro^{U} does not interfere significantly with the helicity of oligoureas, unlike Pro in peptide chains. In H2OC3, two Glu^{U} were replaced with the less hydrophilic Asn^{U} at the ‘b’ sites of pentads (FIG. 1A; 1B). Such substitutions were made to reduce the interaction with water in the polar channel and facilitate faster water flow. To enhance the penetration into lipid bilayers, the analogue H2OC4 was designed by replacing Ala^{U} and Pro^{U} residues with Phe” at position ‘e’ in both pentads of H2OC1 (FIG. 1A; 1B). Such aromatic Phe-type residues are thought to favourably interact with fatty acyl chains and lipid head groups. All oligourea foldamers were synthesized on a solid support using microwave assistance (FIG. 34; Table 2; and FIGS. 6 to 9) and purified according to previously established procedures.

The specific structures described herein are the result of the amino acid sequence of foldamers claimed herein. It is further shown by the data disclosed herein that the specific structures of the foldamers disclosed herein define the transport functional properties of the foldamers, and the membranes comprising the foldamers disclosed herein. It is therefore shown herein that the claimed foldamers exhibit unique structural properties over foldamers disclosed in the art.

### Biophysical Characterization of Foldamers

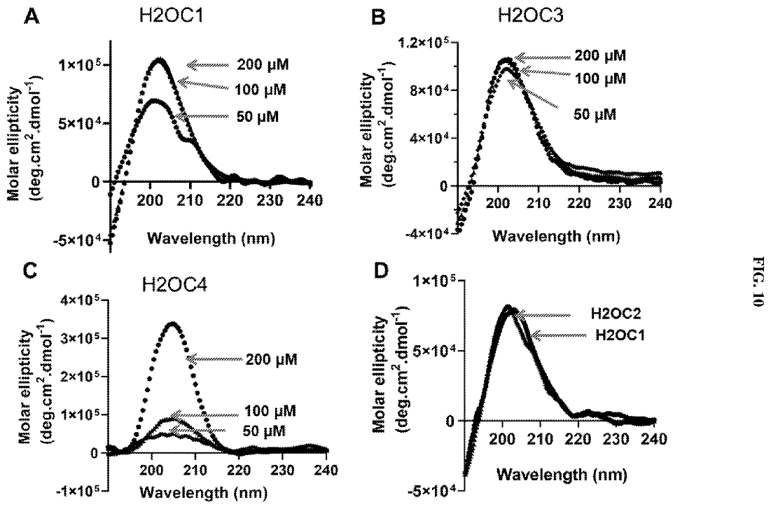

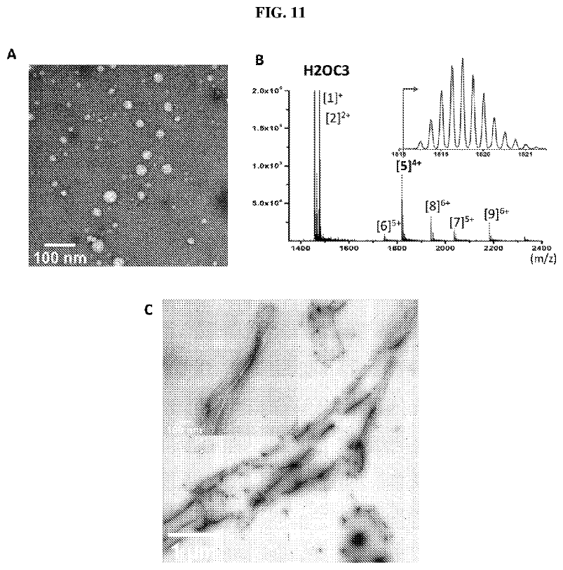

The secondary structure and self-assembly of the foldamers were first investigated by circular dichroism (CD). All spectra showed a maximum at ~202 nm (FIGS. 1C, 1D and 10), indicating helical conformation of H2OC1 to H2OC4 analogues at 100 μM in water. These analogues were shown to exhibit helicity even at lower concentrations. Concentration-dependent circular dichroism experiments of foldamers showed increased molar ellipticity with increasing foldamer concentration, indicating self-assembly in water (FIGS. 1D and 10). Negative-staining TEM studies of H2OC1 and H2OC2 showed the formation of extensive fibre networks in aqueous condition (FIGS. 1E; 1F). H2OC2 showed large fibre bundles with knots (with diameters ranging from about 12 to about 40 nm) consisting of protofilaments with diameter of 3.7±0.8 nm, whereas H2OC1 showed untangled fibres with a diameter of 5.5±0.6 nm (FIGS. 1E to 1F). The TEM observations support their fibre-like self-assembly. In contrast, H2OC3 showed vesicle-like morphology with about 24 to 33 nm diameter (FIG. 11A). H2OC4 formed longer filaments with about 132 to 156 nm width (FIG. 11C). The stoichiometry of oligourea foldamer self-assemblies was next investigated by mass spectrometry. ESI-MS analyses revealed the presence of discrete multimeric species ranging from pentamer to nonamer of H2OC1 and H2OC2 in aqueous condition (FIG. 1G; 1H). In contrast, H2OC3 showed a predominant pentameric species (FIG. 11B). The TEM and ESI-MS results are thus consistent with H2OC1, H2OC2 and H2OC4 forming helical tubes as previously reported.

Molecular Insertion of Foldamer Channels into Lipid Vesicles

To investigate whether H2OC1 and H2OC2 foldamers have the molecular properties to be stably inserted into lipid membranes, solid-state NMR spectroscopy was employed to measure biophysical parameters in a lipid environment. Lipid vesicles composed of a mixture of phosphatidylcholine (PC) and phosphatidylserine (PS) (molar ratio of 4/1) were reconstituted in the presence of H2OC1 and H2OC2 at a molecule-to-lipid ratio of 1/20.

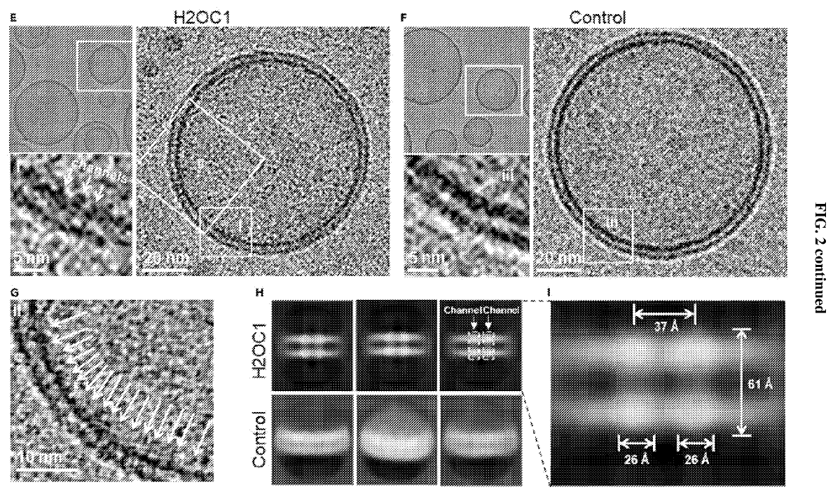

To monitor the impact of foldamer insertion into the lipid vesicles, ³¹P solid-state NMR was first used to probe the lipid phase and membrane curvature effect. PC/PS vesicles exhibited a ³¹P spectral pattern characteristic of a lamellar lipid phase. ³¹P experiments carried out for vesicles containing H2OC1 and H2OC2 showed a comparable asymmetric spectral profile and a similar chemical shift anisotropy (FIG. 2A), indicating that the lipid phase and the membrane curvature of the vesicles were not significantly impacted by the molecular insertion of the foldamers. To monitor the insertion of foldamers into the hydrophobic part of the lipid bilayer, ²H solid-state NMR was used on PC/PS vesicles for which the PC acyl chains were deuterated. Comparable ²H quadrupolar couplings were detected for control vesicles and vesicles incorporating H2OC1 and H2OC2 (FIG. 2B). Since ²H quadrupolar couplings are related to the molecular orientation and the dynamics of the C-²H bonds, this indicates that the foldamer insertion has a negligible effect on the internal lipid dynamic at the level of the acyl chain. Lipid thermotropism was evaluated by monitoring the ²H first spectral moment as a function of the sample temperature (FIG. 2C). It was observed that the melting temperature (Tₘ=285 K) of PC/PS vesicles stayed the same in the presence of the H2OC1 and H2OC2 foldamers. Using spectral deconvolution, individual 2H quadrupolar splittings were employed to derive the lipid order parameters along the PC acyl chain (FIG. 2D) that span half of a bilayer. Control PC/PS vesicles exhibited a characteristic profile of SCD order parameters with a plateau for carbons near the membrane surface and having a high structural order, followed a decreased of order parameters towards the mobile methyl carbon C¹⁴. A similar profile was observed for vesicles incorporating H2OCl and H2OC2, with a slight increase of SCD order parameters in presence of the foldamers, suggesting that their insertion slightly increases lipid acyl chain ordering. Taken together, solid-state NMR experiments indicate a proper and stable insertion of foldamers into lipid vesicles, without perturbations of the lipid phase, thermotropism and internal dynamics.

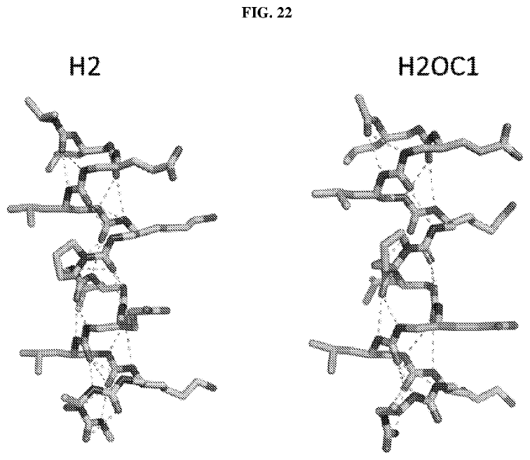

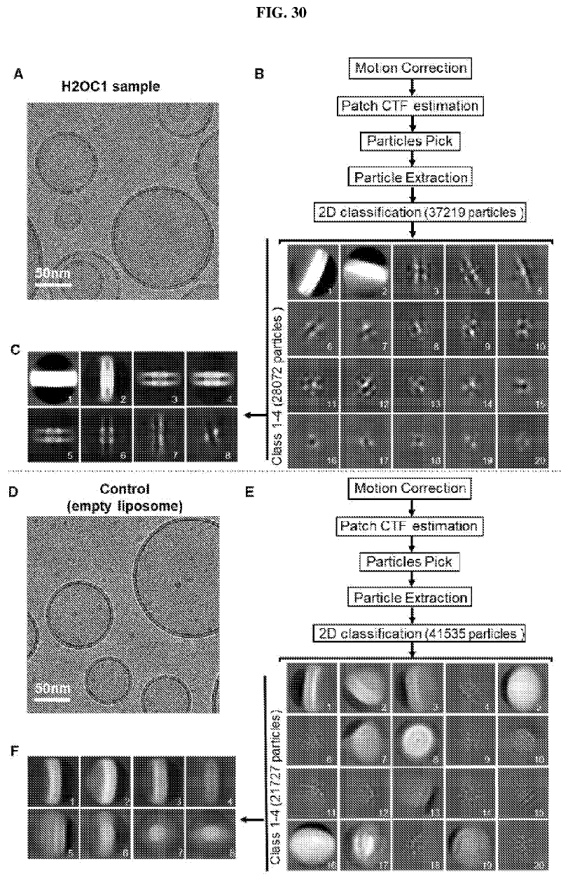

Further, single particle cryoelectron microscopy (cryo-EM) was employed to estimate the number of H2OC1 channels within a unit area of the liposomemembrane with an empty liposome as the control (FIG. 2E-2G and FIG. 30). The cryo-EM image shows that the foldamer channels were inserted in an orderly fashion without perturbating the lipid phase. Under high magnification, rod-shaped densities corresponding to transmembrane channels were observed, which were absent in empty liposome images (FIGS. 2E and 2F). These channels are evenly distributed along the circular plane of the membrane (FIG. 2G). Two-dimensional (2D) classification with a box size of 200 Å yielded average images of two channels embedded in the membrane (FIG. 2H). By contrast, no corresponding dense regions were visible in the 2D averages of the empty liposome control (FIG. 2H). The individual channels were 26 Å wide, consistent with the crystal structure (29 Å). Direct visualization of two neighbouring channels allowed us to further measure their distance (FIG. 21), around 3.7 nm. Together, the cryo-EM analysis revealed that each H2OC1 channel occupies an area of 3.7 nm×3.7 nm, which corresponds to 73,046 channels per mm² at a 1:100 (foldamer to lipid) molar ratio.

### Water Permeability of Foldamer Porin-Type Channels

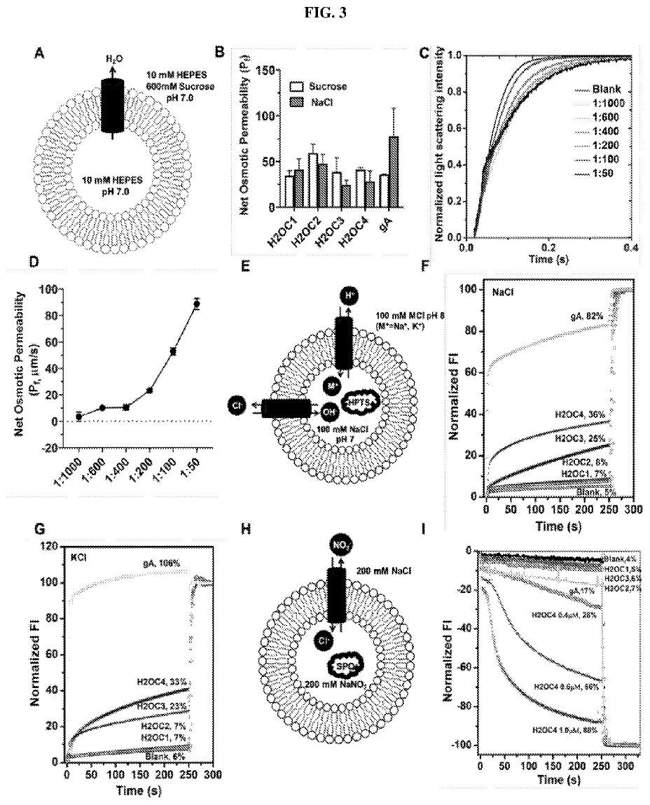

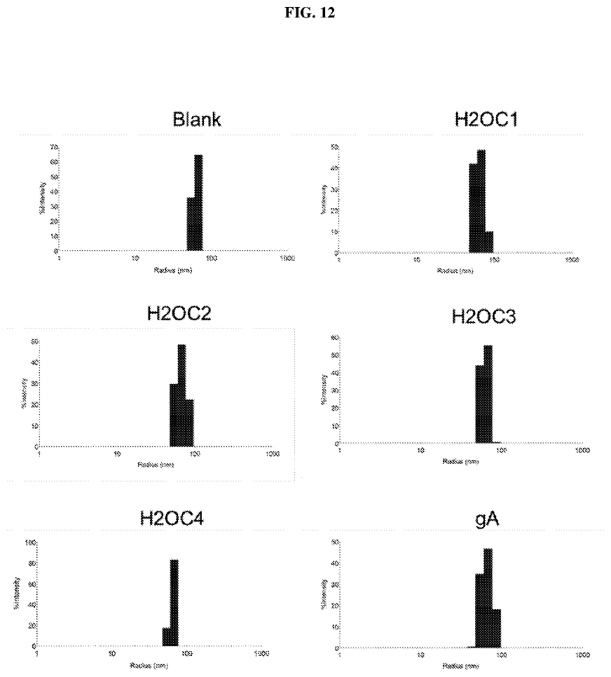

The water permeability in lipid bilayers was measured using a stopped-flow method to capture fast kinetics on the millisecond time scale of water efflux from lipid vesicles led by osmotic pressure difference was determined by monitoring the change in the light scattering intensity of the vesicles (FIG. 3A). Water permeability was quantified by the shrinkage mode, measured in PC/PS (4:1) lipid vesicles. The foldamer-embedded vesicles were exposed to hypertonic osmolytes (sucrose and NaCl) (FIG. 3A; 3B). All four foldamers showed significant water permeability in the presence of sucrose or competitive ionic NaCl used as osmolytes (FIGS. 3B and 12 to 13). H2OC2 showed the highest water permeability compared to other sequences (5- to 7-fold increase in water transport at 1:50 ratio over the control vesicles without H2OC2 foldamer) (FIG. 3B). Additionally, these foldamer channels showed comparable water permeability to that of gramicidin A (gA), a natural ionophore which transports water and cations across the membranes (FIGS. 3B, 12, and 13). Due to the high water permeability of H2OC2, this foldamer was studied more detail.

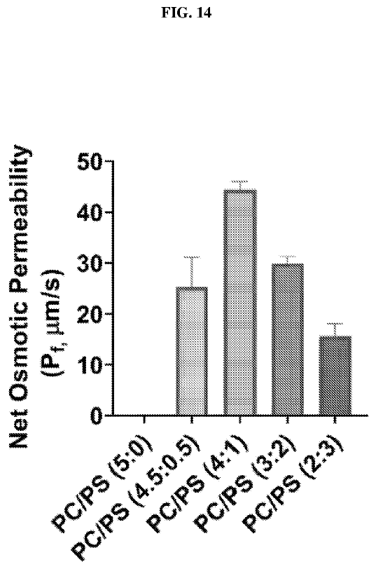

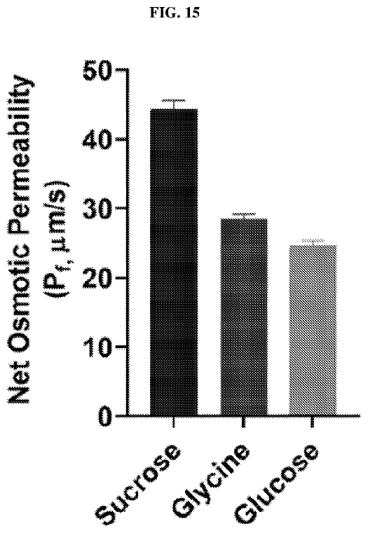

The effect of different PC/PS ratios in vesicles on water permeability of H2OC2 was evaluated (FIG. 14). No detectable water permeability was observed in the presence of pure PC. However, with increasing PS concentration, the permeability increased until PC/PS ratio reached 4:1. Further increase in PS concentration for H2OC2 resulted in decreased water permeability (FIG. 14). Subsequently, H2OC2 and PC/PS vesicles were mixed to obtain foldamer/lipid molar ratios from 1:1000 to 1:50 in 10 mM HEPES buffer, pH 7.0. The light scattering intensity increased with exposure to an equal volume of hypertonic osmolyte (600 mM sucrose) with the increasing foldamer ratio (FIGS. 3C; 2D). This indicates that increasing the molar ratio results in effective increase in incorporation of foldamers into the vesicles, leading to enhanced water permeation. The calculated water permeability (Pf) values of H2OC2 vary from 10.5 μm/s (foldamer/lipid ratio 1:400), 23.2 μm/s (at 1:200) to 88.7 μm/s (at 1:50) (FIG. 3C; 3D), close or improved compared to water permeability observed with gramicidin A (gA) channels. H2OC2 also showed water permeability in the presence of other osmolytes such as glycine and glucose (FIG. 15). Furthermore, the water permeability at pH 4.5 was lower than that at pH 7.0.

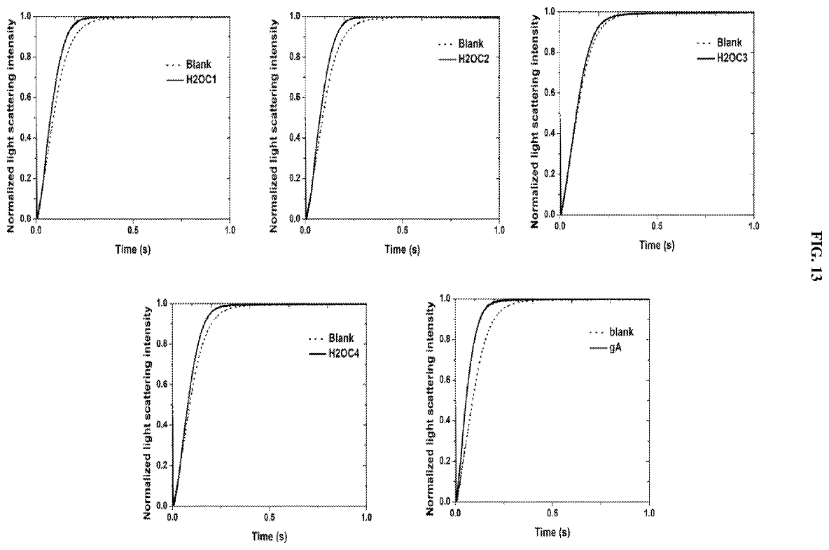

From the cryo-EM data, the channel number was calculated to be about 1,665 per liposome (for a 1:100 molar ratio where 135 μM of H2OC1 was used in 13,500 μMPC/PS). The net osmotic permeability (Pf) of H2OC1 was calculated as 34.44 μm/s. Thus, the calculated single-channel water permeability of H2OC1 was P1=8.08×10⁻¹⁶ cm³/s; and P2=2.70×10⁷ water molecules/s. If it is presumed that H2OC2 forms a similar channel assembly as that of H2OC1 due to their sequence similarities, the inserted channel numbers in PC/PS membranes are also expected to be similar. The net osmotic permeability (Pf) of H2OC2 was calculated as 52.82 μm/s (see FIGS. 13-15). Therefore, the estimated single-channel permeability of H2OC2 was P1=1.21×10⁻¹⁵ cm³/s; and P2=4.08×10⁷ water molecules/s.

### Proton/Ion Transport Properties of Foldamers

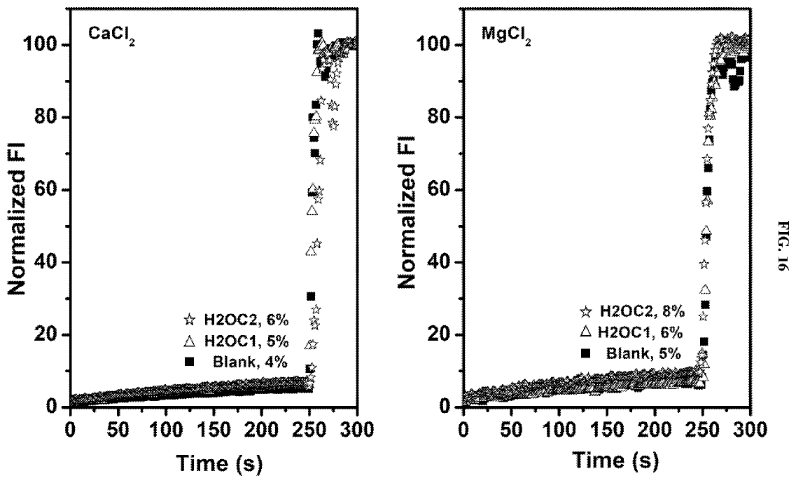

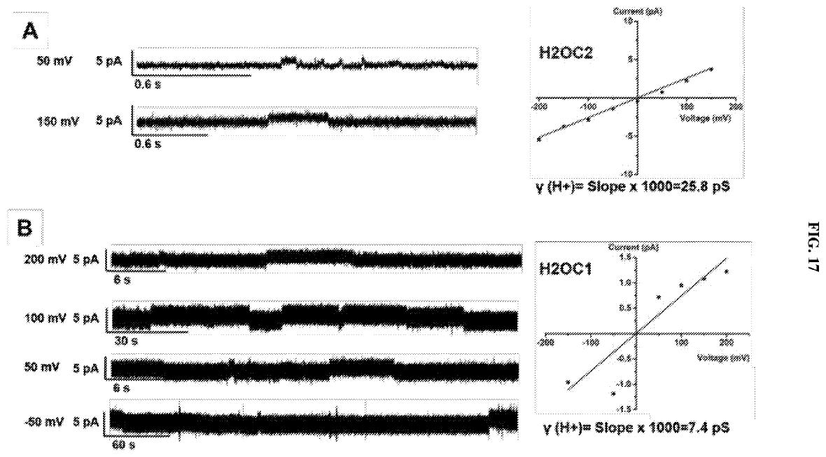

High, selective water transport is a key feature for an artificial water channel (AWC). Another important feature that is equally important for water purification is its ability to reject ions transport. Therefore, the ion transport properties of selected foldamers disclosed herein was tested in PC/PS (4:1) vesicles using standard fluorescence based HPTS assay (FIG. 3E). The HPTS loaded vesicles were incubated with the foldamers for 5 minutes before the experiments. A base pulse (20 μl of 0.5 N NaOH) was given at 50 seconds of the measurement to increase the external pH from 7.0 to 8.0. The natural ionophore gA, a monovalent cation selective channel was used as a positive control (FIGS. 3F; 3G). The changes in fluorescence intensity showed that H2OC3 (36%) and H2OC4 (25%) channels can moderately transport Na⁺ and K⁺ ions. Ion transport facilitated by the foldamers was shown to be much lower than that of gA (FIGS. 3F; 3G). No detectable ion transport activity was observed for H2OC1 (7%) and H2OC2 (8%) in the presence of NaCl and KCl (FIGS. 3F; 3G). In addition, H2OC1 and H2OC2 foldamers were able to reject the divalent ions (FIG. 16). This indicates a strong salt rejection ability of these two foldamers, which are therefore suitable for water purification applications.

Thus, in one example, the foldamers and membranes disclosed herein are selectively ion permeable, wherein the ions can be, but are not limited to, Na⁺, K⁺, Mg²⁺, Ca²⁺, NO₃⁻, and Cl⁻. In another example, the foldamers, and membranes disclosed herein, have the ability to reject salt, if and when present in the solution to be purified. Examples of salts are, but not limited to, NaCl, NaNO₃, MgCl₂, CaCl₂), and KCl.

The chloride permeation through H2OC1 and H2OC2 channels was further investigated using chloride-selective dye 6-methoxy-N-(3-sulfopropyl) quinolinium (SPQ) trapped in PC/PS (4:1) vesicles containing intravesicular NaNO₃ and extravesicular NaCl (FIG. 3H). Oligourea H2OC1, H2OC2 and H2OC3 did not show any detectable chloride transport (FIG. 31). However, concentration-dependent quenching of fluorescence intensity was observed for H2OC4 due to the influx of Cl-ions (FIG. 3I). Collectively, these assays confirm the ion rejection properties of H2OC1 and H2OC2.

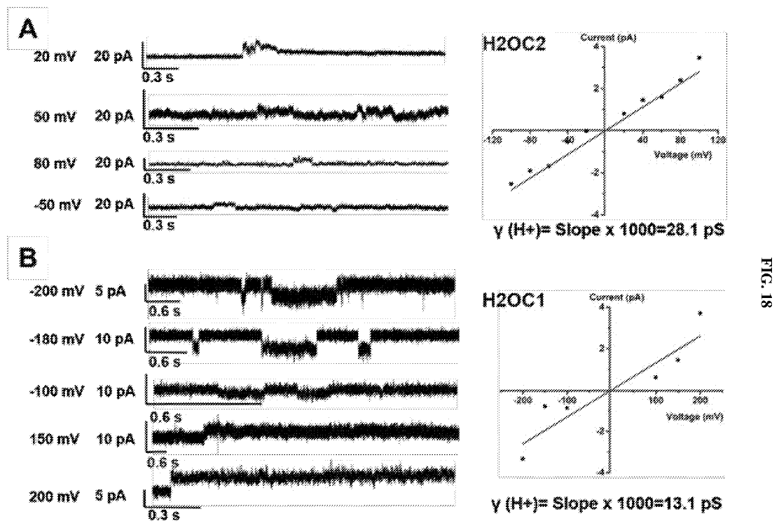

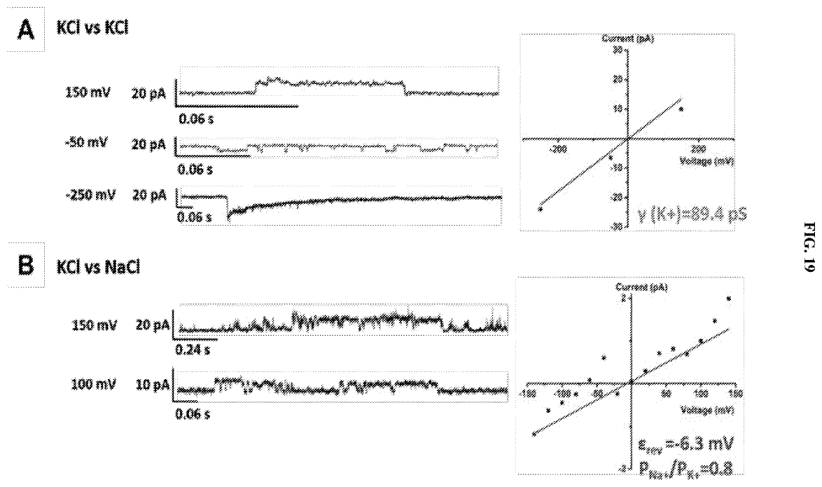

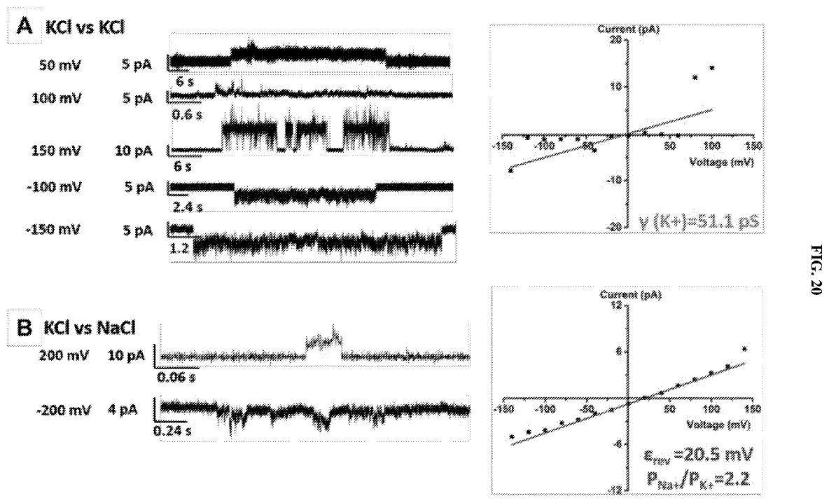

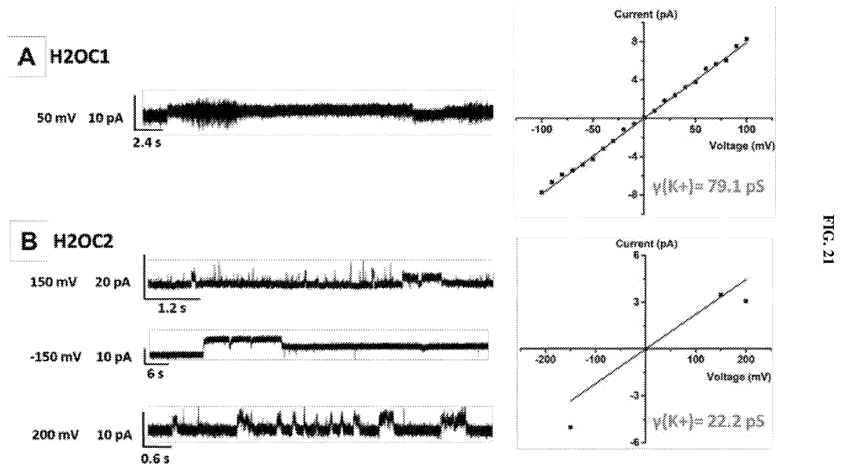

The proton transport activity of oligourea foldamers was evaluated by the patch-clamp experiments in PC:PS (4:1) and DOPC vesicles (FIGS. 17 to 21). H2OC2 showed a low proton conductance rate (γH⁺=25.8 pS) than H2OC1 (γH⁺=7.4 pS) in PC: PS lipid (FIG. 17). The conductance values were at the same level when it came to DOPC lipid as shown in FIG. 18. Moreover, H2OCl presents a better channel shape, longer retention time and higher channel opening probability at both lipid conditions. Along with the water transport activity, it is thought that protons are transferred overall along water wires. Patch clamp single channel current traces and I-V plots of H2OC1 and H2OC2 recorded in symmetrical solutions (cis chamber =trans chamber=1 M KCl solution) and asymmetrical solutions (cis chamber=1 M KCl solution, trans chamber=1 M NaCl solution) using DOPC and PC/PS (4:1) lipids showed no obvious channel activity confirming the previously observed lack of ion transport ability by H2OC1 (FIGS. 19 and 21A) and H2OC2 (FIGS. 20 and 21B).

Thus, in one example, the oligourea foldamer is water permeable. In another example, the oligourea foldamer is selectively ion permeable or ion impermeable.

### Self-Assembled Channel Structure of Foldamer

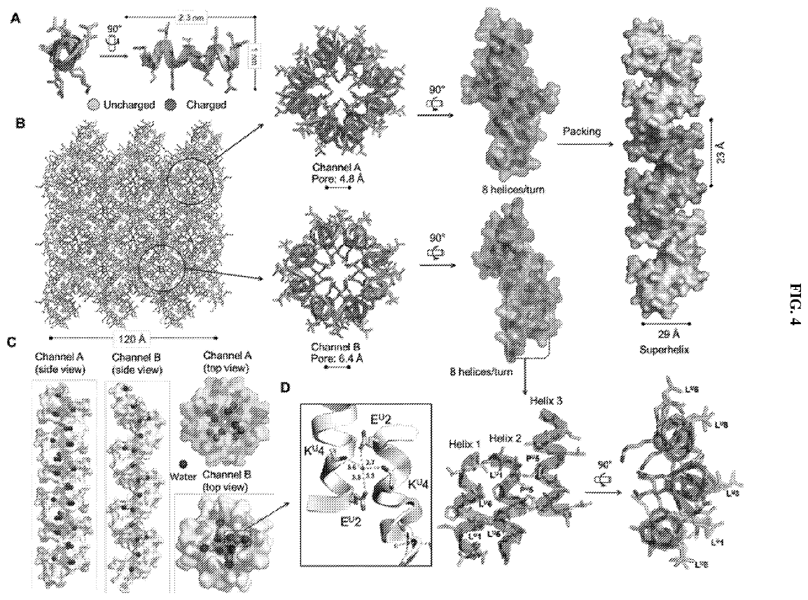

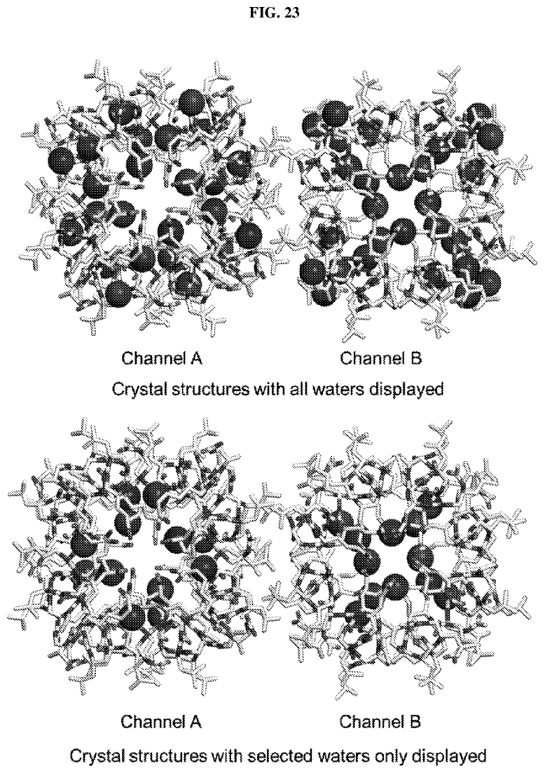

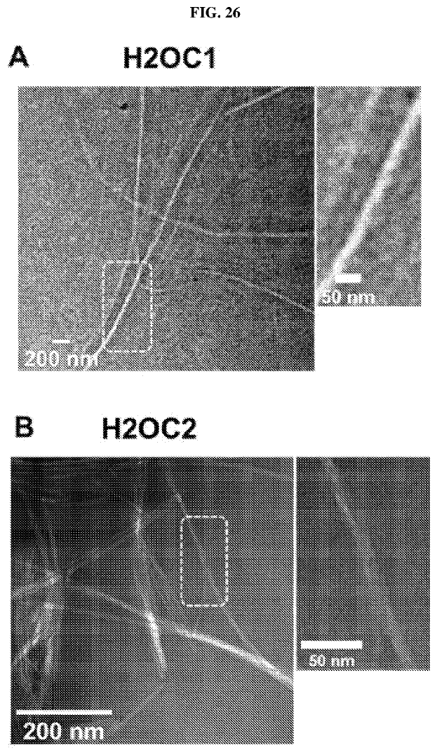

An X-ray crystal structure of foldamer H2OC1 at a high-resolution of 1.2 Å was determined in order to provide atomic-scale details of channel formation via self-assembly. (FIGS. 4, 22 to 24, and Table 3 to 4). The monomers exhibited the design-imposed amphipathic helical conformation consisting of distinct hydrophobic and hydrophilic faces (FIGS. 1A and 4A), similar to those formed from H2 (FIG. 22 and Table 4). Crystal packing revealed oligourea helices forming a self-assembled superhelical channel-type assembly (FIG. 4B). Two distinct channels can be identified in the crystal structure of H₂OC1, namely channels A and B with an external diameter of 29 Å each (FIG. 4B). These channels show apparent pore diameters of 4.8 and 6.4 Å, respectively. In channel B, the electron density maps for C-terminal Lys^{U9}, and Ala^{U10} residues are not ‘visible’ leading to overestimation of its pore size. In both channels, the exterior surface is composed of the hydrophobic residues Le^{U}, Ala^{U}, Pro^{U} located at positions ‘a’, ‘c’ and ‘e’ in the helical-wheel representation. The pore of the channels is lined by the hydrophilic residues Glu” and Lys^{U} situated at positions ‘b’ and ‘d’ (FIG. 4B). Eight oligourea helices per turn associate laterally in a right-handed, staggered, antiparallel orientation by hydrophobic and electrostatic interactions within the superhelical structure. The intricate H-bonding network of salt-bridges between neighbouring oligourea helices greatly contributes to stabilize the pore structure. The hydrophilic pore is hydrated with both H-bonded (to the Gl^{U} and Lys^{U} side chains) and mobile water molecules (FIGS. 4C, 4D, and 23 to 24). A single turn (23 Å) can span across half the thickness of the phospholipid bilayers. Crystal packing also revealed the presence of distorted helices that fill the void spaces between channel assemblies. These helices with a kink near the Pro^{U} and Lys^{U} residues are situated externally, defining four corners surrounding both channel assemblies (FIG. 25). The well-defined self-assembled helical tubular structure of H2OC1 in the crystal (FIG. 4B) suggests a model of interaction between the hydrophobic face of amphipathic foldamer helices and the hydrophobic component of lipid membranes compatible with the formation of pore in the lipid membranes. Without being bound by theory, it is thought that water transport across the membranes occurs via the H-bonding networks between water molecules and the hydrophilic residues in the pore wall (FIGS. 4C; 4D). TEM analysis of H2OC1 under conditions similar to crystallization conditions showed extended fibre assembly with external diameter of about 20.6 nm (FIG. 26A). These fibres may be formed of five- to six-channel units across its diameter. In contrast, H2OC2 fibre bundles are about 9.3 nm in diameter (FIG. 26).

Thus, in one example, an oligourea foldamer is described. In one example, the oligourea foldamer self-assembles. In another example, the oligourea foldamer comprises or consists of one or more sequences, which can be, but are not limited to SEQ ID NO: 1 (Ac-L^{U}E^{U}L^{U}K^{U}P^{U}L^{U}E^{U}L^{U}K^{U}A^{U}-NH₂) and SEQ ID NO: 2 (Ac-L^{U}E^{U}L^{U}K^{U}A^{U}L^{U}E^{U}L^{U}K^{U}A^{U}-NH₂). In one example, the oligourea foldamer sequence is that of SEQ ID NO: 1. In another example, the oligourea foldamer sequence is that of SEQ ID NO: 2. In another example, there is described a compound comprising oligourea foldamers as described herein.

In another example, the oligourea foldamers self-assemble into a three-dimensional nanostructure under aqueous conditions.

In yet another example, the three-dimensional nanostructure is a helix or a pore.

In one example, the pore has an internal diameter of between 4.5 Å to 6.5 Å, between 4.6 Å to 4.9 Å, between 4.8 Å to 6.0 Å, between 4.9 Å to 6.5 Å, between 5.0 Å to 5.5 Å, between 5.8 Å to 6.3 Å, between, or between 6.0 Å to 6.5 Å. In another example, the pore has an internal diameter of about 4.5 Å, about 4.6 Å, about 4.7 Å, about 4.8 Å, about 4.9 Å, about 5.0 Å, about 5.1 Å, about 5.2 Å, about 5.3 Å, about 5.4 Å, about 5.5 Å, about 5.6 Å, about 5.7 Å, about 5.8 Å, about 5.9 Å, about 6.0 Å, about 6.1 Å, about 6.2 Å, about 6.3 Å, or about 6.4 Å.

### All-Atom Molecular Dynamics (MD) Simulations

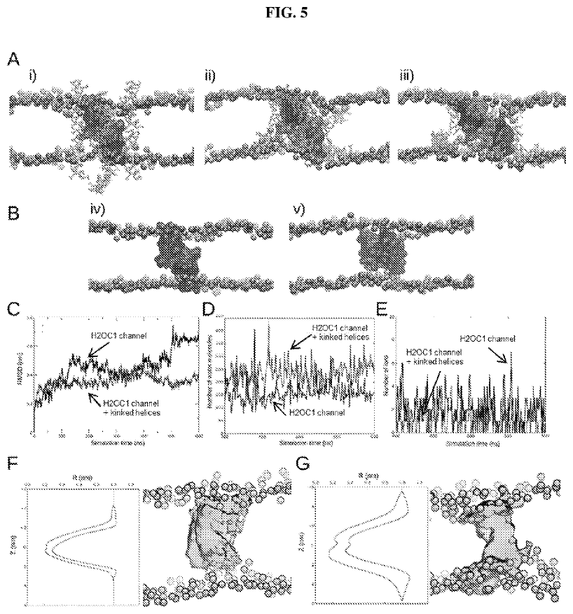

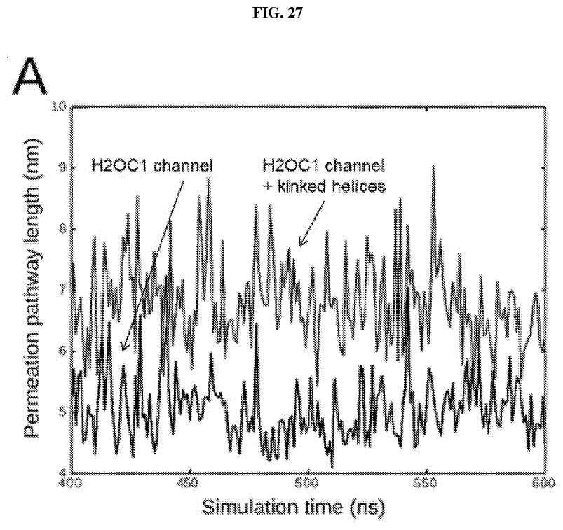

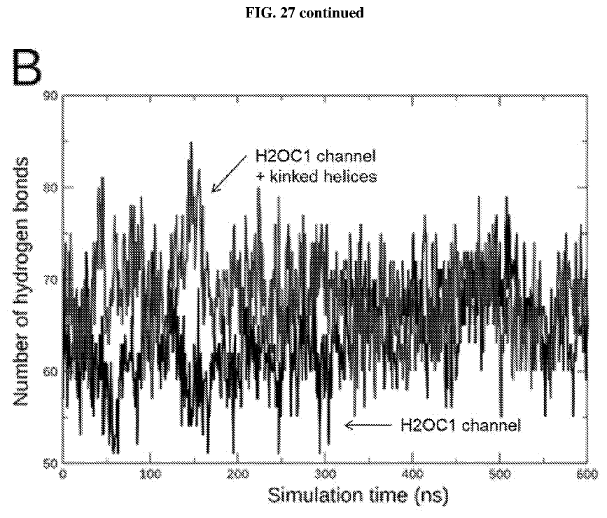

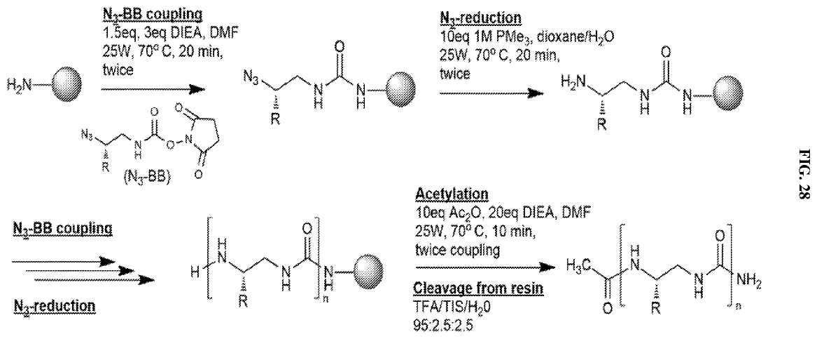

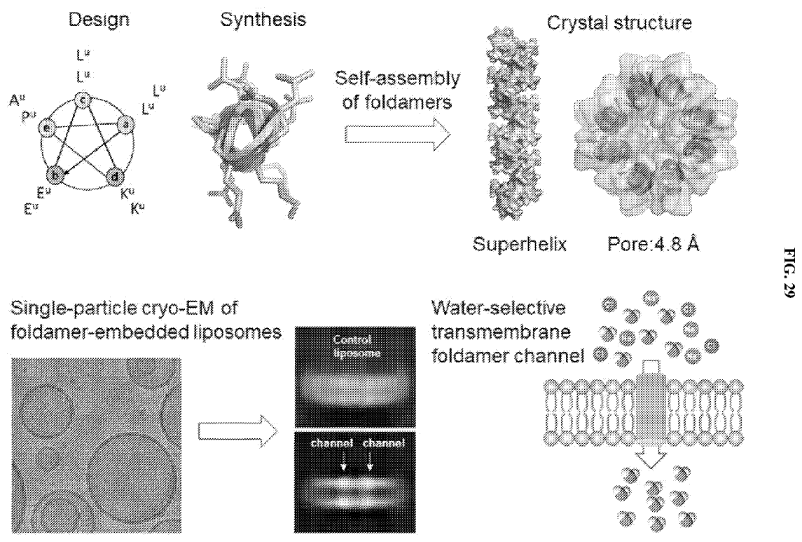

To gain molecular insights into the dynamics of H2OC1 channel in the lipid bilayer, explicitly solvated, all-atom MD simulations were performed. The experimental crystal structure of the H2OC1 channel composed of 8 monomeric helices was used, as well as 16 kinked H2OC1 oligourea helices positioned on the side of the channel. This construct was embedded in a POPC: POPS (4:1 ratio; POPC: 1-palmitoyl-2-oleoyl-sn-glycero-3-phosphocholine, POPS: palmitoyl-oleoyl phosphatidylserine) lipid bilayer (FIG. 5Ai). After 200 nanoseconds of the equilibration simulation with restrained alpha carbon positions of all helical oligoureas, only 12 kinked peptides were observed that were positioned between lipid head groups of the membrane remained bound to the channel (FIG. 5Aii), while those above or below dissociated. After 600 ns of unrestrained production run, the channel retained its supra helical conformation (FIG. 5Aiii) with kinked peptides bound. A control system was also built, which corresponded to H2OC1 channel composed only of 8 monomeric helices in the same lipid environment (FIG. 5Biv). After 200 nanoseconds of equilibration and 600 nanoseconds of the production, the supra helix collapsed resembling a closed and cylindrical conformation (FIG. 5Bv). This is indicated by higher root-mean-square deviation (RMSD) of alpha carbons for the system without kinked helices (FIG. 5D). Although water molecules were found to permeate through both channels, the H2OC1 channel with kinked peptides could transport better water molecules (FIG. 5D). The longer permeation pathway of H2OC1 channel with kinked helices allowed formation of more hydrogen bonds between two glutamate-type residues in each oligourea with water molecules (FIG. 27A-B). On the other hand, a small fraction of ions could enter both channels, in agreement with experimental observations (FIG. 2E; 2I). Averaged radius profiles as well as averaged density of solvent in both channels is shown in FIGS. 5F-5G. Although both channels have a radius in the membrane centre of mass corresponding to about 0.2 nm, the H2OC1 channel with kinked peptides showed a longer permeation pathway. In summary, computer simulations showed that kinked peptides can stabilise the H2OC1 channel, which allows more water molecules to permeate through the membrane.

The present disclosure shows the design and synthesis of oligourea foldamers that form superhelical water channels in aqueous condition stabilized by hydrophobic and electrostatic interactions. Oligourea foldamers H2OC1 and H2OC2 showed water permeability with high salt rejection in liposomes. In contrast, H2OC3 and H2OC4 showed permeability to ions along with water in liposomes. A high-resolution crystal structure of H2OC1 revealed that salt-bridges facilitate intricate H-bonding network among proximal and distal oligourea residues to stabilize the packing that was confirmed by the formation of fibres of the same dimension that were observed by TEM. Solid-state NMR data indicated stable insertion of foldamers without perturbing the lipid vesicles. The design of the amphiphilic foldamers resulted in the formation of self-assembled tertiary structures conferring a hydrophobic exterior and hydrophilic interior lumen filled with H-bonded water clusters. This results in high water permeability across lipid membranes, indicating the use of these foldamers in the production of artificial water channel (AWC) membranes for water purification applications.

Thus, in one example, the oligourea foldamer disclosed herein is water permeable.

Unlike the previously described artificial water channels (AWCs), the foldamers disclosed herein laterally self-assemble to form the channel. This represents a previously unapplied design strategy of using short (10-residue) oligourea foldamers for artificial water channels and other channels/transporters. Using this design strategy, distinct water and ion permeabilities were obtained by altering the sequences of foldamers. The de novo design described herein has various advantages. In one example, changing the hydrophobic and hydrophilic surfaces of these foldamers allows the self-assembly of channels with different diameters and water/ion permeabilities. Also, the design strategy of incorporating polar and nonpolar side chains within the channel lumen allows for selective interactions and transport of cations, anions, and water. This highlights the versatility and potential of the oligourea foldamers disclosed herein for systematic and rational design to achieve different structural and functional properties.

### Structural Differences

Both the H2OC1 and H2OC2 N-terminal are blocked by small, acetyl group. In addition, in H2OC1 and H2OC2, the C-terminal has an amide group. Both these changes affect the oligomerization and pore formation. In H2OC2, additionally, Pro^{U} is replaced by Ala^{U}.

Transmission electron microscopy (TEM) structures show that H2OC2 forms large fiber bundles with knots (diameter ranging from 12.4 to 39.3 nm) compared to H2OC1, which forms untangled fibers of diameter 5.5±0.6 nm.

Crystal structures of H2OC1 shows its oligomerization status. H2OC1 forms only one right-handed superhelix with 8 oligourea helices per superhelical turn. H2OC1 assembly shows two types of hydrophilic pores with internal diameters of 4.8 Å and 6.4 Å.

### Functional Characterization of H2OC1 and H2OC2

The results indicate that both H2OC1 and H2OC2 exhibit high water permeability with high salt rejection across lipid membranes. Using fabricated test membranes, use of H2OC1 and H2OC2 for water purification has been shown.

The structural changes at the N- and C-termini of the claimed peptides led to changes in the self-assembly and channel formation. The pore size of channels formed by H2OC1 are smaller (4.8-6.4 Å) compared to 17 Å pore formed by other peptides know in the art. Based on the similarity in functional properties and, without being bound by theory, it is thought that H2OC2 forms channels with similar pore size as H2OC1. Collectively, this indicates the use of the claimed peptides suitable for water purification.

Oligourea foldamer-embedded membranes can be used in for water filtration by reverse osmosis or forward osmosis methods, as well as sea water reverse osmosis (SWRO) membrane preparation and performance evaluation.

### Uses

Reverse osmosis (RO) is a membrane purification method. The currently available seawater reverse osmosis (SWRO) membranes require around 3.5 kWh/m³ of electricity for routine commercial desalination projects. The process has pre-treatment stage prior to the second pass reverse osmosis and yields drinking water at 50% recovery rate based on the feed water. One strategy to reduce the energy cost is to increase the water permeability rate. But increased water permeability tends to reduce salt rejection by membranes. The commercial thin film composite (TFC) seawater reverse osmosis (SWRO) membranes currently in use have best water permeance of between 1 to 2 Lm⁻² h⁻¹bar⁻¹ with ~99% NaCl rejection. Therefore, novel strategies to develop high-performance seawater reverse osmosis (SWRO) membranes that require lower operational energy are necessary.

Compared to conventional thin film composite (TFC) membranes, test membranes incorporating a selective layer of oligourea foldamer-embedded liposomes on the PSF membranes exhibited enhanced water permeability with ~99% salt rejection. As indicated in Table 1, the test membranes have about 3 Lm⁻² h⁻¹bar⁻¹ water permeability. This indicates that the energy use can be significantly reduced with such membranes. Techniques exist to develop seawater reverse osmosis (SWRO) spiral wound modules and hollow fibre modules, which are the two commonly used membranes. Hence this method combines the advantages of high water permeability, salt rejection, and good scalability for seawater reverse osmosis (SWRO) membrane fabrication. Further, it has application in the reduction of energy used for desalination.

Membrane modules can be fabricated as (a) hollow fibre modules, and (b) as spiral wound modules. These can be of diameters in the range of 2.5-inch and 8-inch (with one meter length), where the 8-inch membrane modules have the seawater reverse osmosis (SWRO) capacity to produce water at commercially meaningful rates of about 100 m³/day (=100,000 L/day).

Another process for water filtration is by forward osmosis (FO) using membranes, which requires less pressure to be applied. This can be applied in industries where water content must be removed without loss of other components present in the solution, including ions. Additional uses include: (a) concentrating fruit juices, (b) purification of brackish water, and (c) in pharmaceutical industries for concentrating products after solution phase manufacturing steps. For such applications, one can use membrane modules incorporating a selective layer of liposome-embedded aquaporin proteins, including those disclosed herein.

### Test Membrane Performance

A polysulfone (PSF) flat sheet, seawater reverse osmosis (SWRO) test membrane was prepared with its polyamide selective layer incorporated with the foldamer-containing liposomes by spraying to a uniform thickness. H2OC1 and H2OC2 membranes showed enhanced water permeability of 3.19±0.01 Lm⁻² h⁻¹bar⁻¹ and 3.09±0.02 Lm⁻² h⁻¹bar⁻¹, respectively, compared to the test membrane coated with liposome lacking foldamers (2.89±0.01 Lm⁻² h⁻¹bar⁻¹) (Table 1). This indicates that the increased water permeability is due to the incorporated foldamer channels. In addition, this data taken together with the disclosure in the present specification, indicates that oligomers comprising the short foldamer molecules disclosed herein possess one or more of the characteristics selected from, for example, high water permeability, high salt rejection, sequence-based functional tunability, convenient design and chemical synthesis, proteolytic stability, and ease of scalability. Furthermore, both membranes containing foldamer channels showed high NaCl rejection (>98.76%). These results shown the feasibility and performance of incorporating H2OC1 and H2OC2 membranes in the fabrication of artificial channel-based biomimetic membrane for brackish reverse osmosis desalination.

Thus, in one example, there is disclosed a permeable membrane comprising the oligourea foldamer disclosed herein or the compound disclosed herein. In another example, the membrane is water permeable and/or selectively ion permeable. In another example, the membrane is ion impermeable.

In another example, the oligourea foldamer rejects 99% of ions. In a further example, the oligourea foldamer is water permeable.

Also envisioned herein is a method of purifying water using the membranes and methods disclosed herein. In one example, the method comprises allowing water to pass through a filtration device comprising the permeable membrane described herein. In yet another example, the method comprises applying the permeable membrane as disclosed herein, wherein the permeable membrane is water permeable and rejects 99% of salt present in the solution to be purified.

In another example, the membranes disclosed herein can be used for test membrane studies, for example, as follows: Biomimetic membranes can be fabricated with the foldamer-embedded liposomes as a water selective (ion rejecting) layer on top of an ultrafiltration membrane. In one example, the test membrane was a polysulfone (PSF) flat sheet, SWRO test membrane-prepared with its polyamide selective layer incorporated with the foldamer-containing liposomes by spraying to a uniform thickness. H2OC1 and H2OC2 test membranes showed enhanced water permeability over the controls without the foldamer incorporation. Techniques exist to develop SWRO spiral wound modules and hollow fiber modules, which are the two commonly used membranes. Hence, this method combines the advantages of high water permeability, salt rejection, and good scalability for SWRO membrane fabrication. Further, it has the potential to reduce energy used for desalination.

An exemplary method of the fabrication of the membranes disclosed herein follows: Membrane modules can be fabricated as (a) hollow fiber modules, and (b) as spiral wound modules. These can be of diameters in the range of 2.5-inch and 8-inch (with one meter length), where the 8-inch membrane modules have the SWRO capacity to produce water at commercially meaningful rates of about 100 m³/day (roughly 100,000 L/day).

In summary, short helical amphiphathic oligourea foldamers were designed with distinct hydrophobic and hydrophilic faces. Two of the foldamers (H2OC1 and H2OC2) obtained by solid phase synthesis self-assembled into channel-type nanostructures that show efficient water permeability across lipid membranes while rejecting ions. A self-assembled quaternary structure with two superhelical scaffolds results in the formation of 4.8 and 6.4 Å inner pores that were observed in the crystal packing of H2OC1. Both pores have hydrophilic interior and hydrophobic exterior surfaces. These findings demonstrate the channel-forming ability of oligourea foldamers in lipid bilayers, and show that such artificial water channels can be beneficial for water purification applications.

Production of recombinant aquaporin at scale can be expensive, and the protein can be prone to degradation by microbial proteases. The oligourea foldamers disclosed herein are resistant to proteases and are therefore less prone to degradation by microbial proteases. The oligourea foldamers disclosed herein can produced using large-scale synthesis methods and utilised in water filtration membranes produced at commercial scale.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

As used in this application, the singular form “a,” “an,” and “the” include plural references unless the context clearly dictates otherwise. For example, the term “a genetic marker” includes a plurality of genetic markers, including mixtures and combinations thereof.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### Tables

TABLE 1
Water flux and salt rejection of flat sheet membranes embedded
with H2OC1 and H2OC2. A polysulfone (PSF), seawater reverse osmosis
(SWRO) flat sheet test membrane (42 cm²) was coated with foldamer-
containing liposomes (foldamer/lipid ratio 1:50). This was
compared to a control membrane and a membrane with liposome
only coating on the membrane surface (PC/PS 4:1) embedded
with foldamer channels were fabricated and used for seawater
reverse osmosis (SWRO) test. The control membranes were coated
with liposomes lacking the foldamers. Membrane performance
was tested for 1 hour with 35 g/l NaCl solution (NaCl concentration
35 000 ppm) at an operating pressure of 50 bar, and a cross-
flow velocity of 10 cm/s.

| Membrane | Permeability, A | Salt Rejection, |
|---|---|---|
| (Flat sheet SWRO) | (LMH/bar) | R (%) |
| Control (without PC/PS) | 2.70 ± 0.07 | 99.19 ± 0.10 |
| Blank PC/PS | 2.89 ± 0.02 | 98.89 ± 0.33 |
| H2OC1-PC/PS | 3.20 ± 0.02 | 98.76 ± 0.28 |
| H2OC2-PC/PS | 3.09 ± 0.03 | 99.00 ± 0.13 |

TABLE 2
Oligourea foldamer sequences.
Superscript “U” indicates urea linkage.

| SEQ ID | | | Expected | Observed M.W. |
|---|---|---|---|---|
| NO: | Code | Foldamer sequence | Mw (Da) | (Da) |
| 1 | H20C1 | Ac-Leu^{U} Glu^{U} Leu^{U} Lys^{U} Pro^{U} | 1484.88 | 1485.25 Da ([M+H]⁺), |
| | | Leu^{U} Glu^{U} Leu^{U} Lys^{U} Ala^{U}-NH₂ | | 743.19 Da ([M+2H]²⁺), |
| | | | | 495.82 Da ([M+3H]³⁺) |
| 2 | H20C2 | Ac-Leu^{U} Glu^{U} Leu^{U} Lys^{U} Ala^{U} | 1458.84 | 1459.99 Da ([M+H]⁺), |
| | | Leu^{U} Glu^{U} Leu^{U} Lys^{U} Ala^{U}-NH₂ | | 730.00 Da ([M+2H]²⁺), |
| | | | | 486.99 Da ([M+3H]³⁺) |
| 3 | H20C3 | Ac-Leu^{U} Asnu Leu^{U} Lys^{U} Pro^{U} | 1454.00 | 1455.13 Da ([M+H]⁺), |
| | | Leu^{U} Asnu Leu^{U} Lys^{U} Ala^{U}-NH₂ | | 728.08 Da ([M+2H]²⁺), |
| | | | | 485.73 Da ([M+3H]³⁺) |
| 4 | H20C4 | Ac-Leu^{U} Glu^{U} Leu^{U} Lys^{U} Phe^{U} | 1611.03 | 1612.04 Da ([M+H]⁺), |
| | | Leu^{U} Glu^{U} Leu^{U} Lys^{U} Phe^{U}-NH₂ | | 806.04 Da ([M+2H]²⁺), |
| | | | | 537.69 Da ([M+3H]³⁺) |

TABLE 3
Data collection and refinement statistics for
X-ray crystal structure of foldamer H2OC1.

| | |
|---|---|
| Crystallization condition | 0.1M HEPES pH 7.5, |
| | 0.2M ammonium acetate, |
| | 15% v/v isopropanol |

Data collection

| Space group | P4₁ | |
|---|---|---|
| a, b, c (Å) | 39.83, 39.83, 36.46 | |
| α, β, γ (°) | 90.00, 90.00, 90.00 | |
| Resolution (Å) | 39.83-1.20 | (1.26-1.20) |
| Rₘₑₐₛ (%) | 12.8 | (42.3) |
| I/σ | 8.9 | (4.1) |
| Reflections (total) | 109117 | |
| Reflections (unique) | 17988 | |
| Completeness (%) | 99.5 | (96.9) |
| Redundancy | 6.1 | (5.2) |

Refinement

| | |
|---|---|
| Resolution (Å) | 39.83-1.20 |
| R_{work}/R_{free} (%) | 15.1/18.6 |
| Atoms | 515 |
| Waters | 30 |
| Overall B-factor (Å²) | 19.17 |

R.m.s deviations

| | |
|---|---|
| Bond-lengths (Å) | 0.019 |
| Bond-angles (°) | 2.796 |
| CCDC code | 2211250 |

TABLE 4
Comparison of primary sequences and self-assembled
structures of H2OC1, H2, and other H2 analogues.

| | | H2′ | H2′ | |
|---|---|---|---|---|
| | H2 | (P6₁) | (P4₁22) | H2OC1 |
| N-terminal | isopropyl | isopropyl | isopropyl | acetyl |
| C-terminal | methylamine | amide | amide | amide |
| Intra helical | 22 | 21 | 19 | 17 |
| H-bonding | | | | |
| Helix length | 22.9 | 23.5 | 23.4 | 23.0 |
| (Å) | | | | |
| Packing | 12 helices/ | 12 helices/ | 8 helices/ | 8 helices/ |
| | turn | turn | turn | turn |
| Pore size (Å) | 17 | 11 | 5 | 4.8 |

TABLE 5
Comparison between Aquaporin and oligourea foldamers

| | Aquaporin | Oligourea Foldamers |
|---|---|---|
| 1 | High water selectivity with high | High water selectivity with |
| | salt rejection | high salt rejection |
| 2 | Protein - with peptide bonds | Non-natural oligourea bonds |
| 3 | Susceptible to proteolytic/ | Resistant to proteolysis/ |
| | microbial degradation | microbes |
| 4 | Can be denatured (e.g., by excess | Not denatured, stable molecules |
| | heat) | |
| 5 | Tedious production of recombinant | Ease of chemical synthesis - |
| | protein - subject to batch-to-batch | better control, cost effective |
| | variations | |
| 6 | Larger footprint per AQP molecule | Smaller molecules - can be |
| | on a membrane | packed to higher density |
| 7 | Fine tuning - protein engineering | Amenable for fine tuning by |
| | is difficult | sequence alterations |
| 8 | Established methods to fabricate | Similar methods can be used |
| | biomimetic membranes using | for oligourea foldamer |
| | AQP-embedded liposomes | membranes |

### EXPERIMENTAL SECTION

### Materials and Methods

All reagents for the synthesis of foldamers were purchased from Sigma-Aldrich unless stated otherwise. Lipids were purchased from Avanti-polar lipids. Gramicidin A, 8-hydroxypyrene-1,3,6-trisulfonate (HPTS), [6-Methoxy-N-(3-sulfopropyl) quinolinium] (SPQ) were obtained from Sigma-Aldrich for fluorescence-based assays. Milli-Q water was used to prepare all buffers and in biophysical experiments (CD, TEM, crystallization).

### Data and Code Availability: Structure Determination by X-Ray Crystallography

No codes were generated uniquely for this study. The CCDC code for the crystal structure of foldamer H2OC1 is: 2211250, and the data collection and refinement statistics for the X-ray crystal structure are provided in Table 3.

### Synthesis of Building Blocks and Oligourea Foldamers

Oligourea foldamers were synthesized by standard solid phase peptide synthesis methods using azide chemistry. Synthesis of appropriate azidoalkyl succinimidyl carbamate monomers was carried out by solution phase chemistry methods published earlier. NovaPEG Rink amide resin (0.45 mmol/g) was used to synthesize the foldamers. The synthesized foldamers were purified by reversed-phase high-performance liquid chromatography (RP-HPLC) using C₁₈ column (C₁₈-RP HPLC) and characterized by mass spectrometry (MS) and analytical RP-HPLC.

### Solid Phase Synthesis of Full Oligourea

The compounds H2OC1, H2OC2, H2OC3 and H2OC4 were synthesized according to previously reported procedures in a polypropylene SPE tube in microwave reactor (CEM Discover) on NovaPEG Rink amide resin (NovaBiochem substitution 0.45 mmol/g) using variable scales (0.050-0.075 mmol). The resin was swelled in dichloromethane (DCM) (3 mL) and in dimethylformamide (DMF) (3 mL) for 2 hours. Activated N3-BB (150 μmol, 1.5 equiv.) and DIEA (40 μL, 300 μmol, 3 equiv.) were dissolved in DMF (2 mL) and the solution was added to the reaction vessel. N₂ purge and bubbling in the vessel were performed. All microwave experiments were conducted at atmospheric pressure. The vessel was then placed inside the microwave reactor and irradiated (70° C., 25 W, 20 minutes). After 20 minutes, the resin was filtered and washed with DMF (4×3 mL). This coupling step was repeated a second time. The resin was washed with a mixture of 1,4-dioxane: H₂O (i.e. reduction solvent, 7:3 v/v, 4×3 mL). Then, 1M PMe3 solution in THF (0.75 mL, 750 μmol, 10 equiv.) and reduction solvent (3 mL) was added. The Staudinger reaction was performed to reduce the azide group under the microwave irradiation (70° C., 25 W, 15 minutes). After the reaction, the resin was filtered and washed with reduction solvent (3×3 mL) and DMF (3×3 mL). The deprotection of Teoc group was performed for 2 h at RT in IM TBAF solution (3 mL, 20 equiv. per Teoc) and DMF (1.5 mL). The deprotection reaction was repeated once. All steps were monitored by chloranil test. After reduction of the last residue of the sequence, acetic anhydride (76 μL, 10 eq) and DIEA (267 μL, 2000 μmol, 20 equiv.) in DMF were added to the resin to perform the N-terminal capping under microwave irradiation (70° C., 25 W, 10 minutes). After the reaction, the resin was filtered and washed with DMF (4×3 mL).

Before the cleavage, the resin was moved to the syringe with filter, and washed with DMF (4×3 mL) and DCM (5×2 mL). The cleavage was performed under acidic conditions, with trifluoracetic acid TFA (95%)/TIS (2.5%)/H₂O (2.5%) (total volume 4 mL) for 4 hours. Resulting filtrates were evaporated. Oligourea was precipitated in diethyl ether, then dried. The crude solid was dissolved in acetonitrile/deionized water ACN: DW=1:9 and lyophilized. Purity was checked by analytical HPLC (C18 column, method: 10-100% B/10 min, A: Milli-Q H₂O+0.1% TFA, B: ACN+0.1% TFA, flow=1 mL/min, T=50° C., 2=214 nm). The product was purified by prep C18-RP-HPLC (Macherey-Nagel Nucleodur 100-5 C18ec column, method: 40-100% B; 20 min, A: Milli-Q H₂O+0.1% TFA, B: ACN+0.1% TFA, flow 20 mL/min, λ=214 nm). The counterion was exchanged by lyophilizing powder with HCl solution (1. 0.05 N HCl_{(aq)}, 2. 0.1N HCl_{(aq)}, 3. MQ H₂O).

### Circular Dichroism (CD)

CD experiments of foldamers were carried out using a J-1100 Circular Dichroism spectrophotometer. Experiments were measured in a quartz cuvette with path length of 1 mm in water at foldamer concentration of 100 μM. Concentration-dependent CD measurements of H2OC1 and H2OC2 was carried out in the range of 12.5 μM to 200 μM. Data were collected at 20° C. at 190-260 nm wavelength at 0.2 interval at a speed of 50 nm/min with three accumulations. Data were plotted using Origin Pro after subtracting from blank.

### Transmission Electron Microscopy (TEM)

For transmission electron microscopy (TEM) visualization, foldamer samples at a concentration of 200 μM in 10 mM HEPES at pH 7.0 were incubated at room temperature for 3 days before the experiments. A 5 μL of sample was deposited on glow discharge carbon coated copper grid (200 mesh) and incubated for 2 minutes. Excess sample was soaked with filter paper followed by negative staining two times with 2% uranyl acetate and dried with filter paper. The grid was observed under electron microscope (JEOL 1400Flash TEM).

### Mass Spectrometry Analysis

ESI-MS was performed using a Synapt-G2Si (Waters, UK) instrument. Foldamers were analysed in 10 mM HEPES pH 7.0 at a concentration of 200 μM with a pump flow rate 300 μL min-1 and source voltage 3kVA. The samples were eluted using methanol in the presence of 0.1% formic acid. The data analyses were performed using MassLynx and MaxEnt 1 software. Data were plotted using Origin pro 8.

### Studies of Foldamer-Phospholipid Interaction Using Solid-State NMR

Foldamers H2OC1 and H2OC2 were added to liposomes (DMPC-d54 and POPS at 4:1 molar ratio) at foldamer: lipid ratio of 1:20. A quadrupolar spin-echo sequence was applied at a 2H frequency of 76.8 MHz on a 500 MHz (11.7 T) Bruker Avance III NMR spectrometer for 2H static wide-line solid-state NMR experiments. Further, a Hahn-echo sequence was applied at a 31P frequency of 161.9 MHz on a 400 MHz (9.4 T) Bruker Avance III HD NMR spectrometer for 31P static wide-line solid-state NMR. Control data were obtained with lipids without foldamers. Data were acquired at different temperatures (273-318 K).

Single Particle Cryo-EM to Determine Insertion of H2OC1 Channels into Lipid Vesicles

Liposome samples with or without H2OC1 on glow-discharged Quantifoil holey gold grids (R 1.2/1.3, Cu 400 mesh) were plunge-frozen in liquid ethane cooled by liquid nitrogen (FEI Vitrobot System). Cryo-EM data were collected as 34-frame movies (130,000× magnification) on a Titan Krios electron microscope (Thermo Fisher Scientific). Data were processed using CryoSPARC. 2D averages of selected particles (37,219 particles of H2OC1 and 41,535 particles from empty liposomes picked by “Blob picker” after “patch CTF estimation”) were obtained by running “2D classification” in CryoSPARC. The number of channels per liposome was calculated based on the dimensions of the liposomes and channels as described below.

### Cryo-EM Sample Preparation and Data Collection

Specifically, 4 μl of liposome samples were applied to glow-discharged Quantifoil holey gold grids (R 1.2/1.3, Cu 400 mesh). Grids were blotted for 3 seconds at 22° C., 100% relative humidity and plunge-frozen in liquid ethane cooled by liquid nitrogen using a FEI Vitrobot System. Cryo-EM data were collected by Titan Krios electron microscope (Thermo Fisher Scientific), equipped with a K3 Summit direct electron detector (Gatan). 34-frame movies were collected at 130,000× magnification with a physical pixel size of 0.671 A/pixel. The exposure time was 6 seconds. The dose was 39 e/Å per movie stack. The movie stacks were collected using SerialEM program.

### Cryo-EM Image Process

EM data were processed using CryoSPARC (v3.3.2). Estimating and correcting for fullframe motion as well as sample deformation was performed using “Patch motion (M)”. The “Patch CTF estimation” was used to estimate defocus variation for tilted, bent, deformed samples. “Blob picker” was applied to particle picking with a box of 200 Å. A total of 37,219 particles of H2OC1 and 41535 particles from empty liposome were extracted. Two-dimensional (2D) averages were obtained through running “2D classification” for two rounds in CryoSPARC.

According to the results of 2D average, the average distance between each two channels is 3.7 nm, so each channel occupies an area of 3.7 nm×3.7 nm, the number of channels per unit area is:

$$\frac{1}{( 3.7 nm \times 3.7 nm )} = \frac{1 \times {10}^{6}}{( 3.7 μm \times 3.7 μm )} = 73046 / {μm}^{2}$$

The radius of the imaged liposome was 42.6 nm. The total surface area of liposome was 4πr2=22793.38 nm². Therefore, total number of channels per liposome=no. of channels x surface area of liposome=1665 channels per liposome at 1:100 molar ratio.

### Size Measurement by Dynamic Light Scattering (DLS)

The size of vesicles and foldamers embedded vesicles were determined using dynamic light scattering in Dynapro Wyatt technology. The vesicle samples were centrifuged at 12000 rpm for 20 minutes before the measurements. The measurements data were averaged in triplicates.

### Water Transport Assay by Stopped-Flow Method

In summary, the water permeability was measured using PC: PS (4:1 molar ratio) liposomes with various foldamers (1:100 molar ratio) on a stopped-flow instrument (Chirascan circular dichroism spectrometer, Applied Photophysics, UK).51 The liposomes were exposed to hypertonic osmolytes (600 mM sucrose) leading to shrinkage due to water efflux.

In detail, the samples were prepared by film rehydration method. L-α-phosphatidylcholine (PC)/L-α-phosphatidylserine (PS) (4:1) were mixed in methanol and chloroform (1:1) in round bottom flask and evaporated under reduced pressure using rotavapor overnight. The resulting thin lipid film was rehydrated with buffer (10 mM HEPES pH 7.0) and mixed well to detach the lipids from the glass surface with occasional vortexing. The mixture was further subjected to 9 freeze-thaw cycles (liq. N2 1 minute and heating dry bath 55° C. for 2 minutes) and extruded through 0.2 μM membrane filter. The large unilamellar vesicles (LUVs) obtained by this method contained 5 mM lipids and stored at 4° C. until measurement done.

The particle size of LUV was confirmed using DynaPro dynamic light scattering (DLS). The water permeability was measured on a stopped-flow instrument (Chirascan circular dichroism spectrometer, Applied photophysics, UK). PC/PS (4:1) lipid vesicles (100 μL, 5 mM in 10 mM HEPES 7.0) and foldamer (5 μL, 1 mM foldamer stock in double distilled water) were mixed at molar ratio of 100 and equilibrated for 5 minutes before the measurements. The vesicles were exposed to hypertonic osmolytes (600 mM sucrose) leading to shrinkage of vesicles due to water efflux. The abrupt decrease of vesicles size was monitored by increased light scattering intensity. The faster size change with foldamer-incorporated vesicles compared to non-incorporated vesicles indicates a higher water permeability in the former. The changes in light scattering with time due to water efflux from vesicles with or without channels can determine water permeability (Pf in cm³/s). To obtain net osmotic permeability, the Pf (blank) value of blank vesicles must be deducted from Pf_{(channel)}. The changes of light scattering intensity were recorded at 572 nm wavelength and fitted the curves with stretched exponential function using Chirascan software and plotted using Origin 8.5 software.

$$y = A exp ( - {kx}^{b} ) + y 0$$

where y=change in light scattering; k=exponential coefficient depicting change in light scattering; x=time and b=constant factor. The osmotic permeability was calculated using following equation.

$$Pf = k / [ ( S / {V}_{0} ) \times Vw \times Δ osm ]$$

S and V₀ are the initial surface area and volume of the vesicles, respectively; Vw is the molar volume of water, and Δosm is the osmolarity difference.

### Measurements of Ion Transport Activity

The ion transport activities of the foldamers were measured in PC: PS liposomes (4:1 molar ratio) containing pH-sensitive HPTS (1 mM) dye using Shimadzu RF-6000 fluorescence spectrophotometer. Similarly, chloride-selective transport was measured using SPQ dye.

### Preparation of PC/PS (4:1) LUV

PC/PS lipids were mixed at 4:1 molar ratio in methanol and chloroform (1:1) in round bottom flask and evaporated under reduced pressure using rotavapor overnight. The film was hydrated with buffer (10 mM HEPES, 100 mM NaCl pH 7.0) having pH-sensitive 8-hydroxypyrene-1,3,6-trisulfonic acid (HPTS, 1 mM) dye. The mixture was further subjected to 9 freeze-thaw cycles (liq. N2 1 minute and heating dry bath 55° C. for 2 minutes) and extruded through 0.2 μM polycarbonate membrane filter to yield homogeneous suspension of LUVs. The unencapsulated HPTS dye was removed by size-exclusion chromatography using Sephadex G-50 column and obtained 5 mM lipid stock at the end and stored at 4° C. until measurement done.

### Ion Transport Activity by HPTS Assay

These HPTS containing PC/PS (4:1) vesicles (40 μL, 5 mM in 10 mM HEPES, 100 mM NaCl pH 7.0) was added to the buffer (1.95 mL, 10 mM HEPES, 100 mM NaCl, pH 7.0). The foldamers (10 μL, 1 mM foldamer stock in double distilled water) and vesicles was equilibrated for 5 minutes before the experiments. A base pulse (20 μL, 0.5M NaOH) was added at 50 seconds of the measurement to increase the pH from 7 to 8. The emission was monitored at 510 nm with excitations at both 403 and 460 nm simultaneously for 300 seconds using fluorescence spectrophotometer. The vesicles were lysed at the end of the measurements by adding 10% Triton X-100 to obtain maximum fluorescence emission. For data analysis and comparison, time (X-axis) was normalized between the point of foldamer addition (i.e. t=50 seconds was normalized to t=0 seconds) and end point of experiment (i.e. t=300 s was normalized to t=250 seconds). The data was plotted as a ratiometric value of 1460/1403 and normalized (IF). IF=It−I0/(I∞−I0), where It and 10 are the ratiometric values of 1460/1403 before addition of Triton X-100 and I∞ is the ratiometric values right after addition of Triton X-100.

### SPQ Assay for Chloride-Selective Transport

PC/PS lipids were mixed at 4:1 molar ratio followed by addition with methanol and chloroform (1:1) in round bottom flask and evaporated under reduced pressure using rotavapor. After drying the resulting film for overnight at room temperature, the film was rehydrated 200 mM NaNO₃ containing chloride selective SPQ dye (1 mM). The purified vesicles were prepared as mentioned above. The SPQ containing vesicle suspensions (40 μL, 200 mM NaNO₃) was added to 200 mM NaCl (1.95 mL). The foldamers (10 μL, 1 mM foldamer stock in double distilled water) was added at 50 seconds of the experiments. The emission was measured at 430 nm with excitations at 360 nm for 300 seconds using fluorescence spectrophotometer. The vesicles were lysed at the end of the measurements by adding 10% Triton X-100 to obtain maximum change in dye fluorescence emission. For data analysis and comparison, time (X-axis) was normalized between the point of foldamer addition (i.e. t=50 seconds was normalized to t=0 seconds) and end point of experiment (i.e. t=300 seconds was normalized to t=250 seconds). The data was normalized using the equation IF=It−I0/(I0−I∞), where I0 is fluorescence intensity just before addition of compound at 50 seconds, It is fluorescence intensity at time t and I∞ is fluorescence intensity after addition of Triton X-100 after an additional 250 seconds.

### Single-Channel Current Measurement Using Planar Lipid Bilayer Workstation

Planar lipid bilayers were formed by brushing 0.2 mL of 4:1 PC: PS- or DOPC-containing n-decane around the aperture. Single-channel current traces (proton or ion transport) were tested at different voltages using patch-clamp techniques.

### Measurement of Proton Transport (in pS Units)

A mixture of PC: PS (4:1), or DOPC (1,2-dioleoyl-sn-glycero-3-phosphocholine, Avanti Polar lipids, 25 mg/ml in CHCl₃) was dried under N₂ gas for 1 hour and then redissolved in decane. Salt bridges (KCl/Agar) were placed in the chambers filled with 0.1 M HCl solution, attaching electrodes (Ag/AgCl) which were placed in KCl solution (1 M). Planar lipid bilayers were formed by brushing 0.2 μL of lipid-containing n-decane solution around the aperture, and a stable bilayer were obtained with a capacitance value ranging from 80 to 150 pF without applying any voltage. Single channel current traces were tested repeatedly for capacitance and resistance at different voltage. The obtained data was collected by ClampFit 10.3.1.5, and then analysed in Origin, fitting using a linear equation of y=a+bx where slope b is the conductance value (γ), unit: nS.

### Measurement of Ion Transport (in pS Units)

A solution of DOPC (Avanti Polar lipids, 25 mg/ml in CHCl₃) was dried under N₂ gas for 1 hour and then redissolved in decane. Salt bridges (KCl/Agar) were placed in the chambers filled with KCl buffer (1 M, 10 mM HEPES, 10 mM Tris), attaching electrodes (Ag/AgCl) which were placed in KCl solution (1 M). Planar lipid bilayers were formed by brushing 0.2 μL of lipid-containing n-decane solution around the aperture, and a stable bilayer were obtained with a capacitance value ranging from 80 to 150 pF without applying any voltage. Single channel current traces were tested repeatedly for capacitance and resistance at different voltage. The obtained data was collected by ClampFit 10.3.1.5, and then analysed in Origin, fitting using a linear equation of y=a +bx where slope b is the conductance value (y), unit: nS.

Measurement of Ion Selectivity Ratio (P_{Na}⁺/P_{K}⁺)

KCl buffer (1 M, 10 mM HEPES, 10 mM Tris) was used in the cis chamber and the trans chamber was still filled in NaCl buffer (1 M, 10 mM HEPES, 10 mM Tris). The obtained data was fitted ith the following Goldman-Hodgkin-Katz equation for calculation: εrev=RT/F×In(PNa+/PK+), R-universal gas constant (8.314 J·K⁻¹·mol⁻¹), T=300 K, F=Faraday's constant (96485 C·mol⁻¹), P is the permeability of sample for ions. ¿ rev was determined by fitting using a linear equation of y=a +bx, where—intercept/slope (−a/b) is the reverse potential value (εrev).

### Structure Determination by X-Ray Crystallography

H2OC1 (10 mg/mL in water) were crystallized using sparse-matrix screening kits (Cation suite [Nextal] and Proplex [Molecular Dimensions]) in 96-well plates by sitting-drops method. Crystals were optimized in 24-well plates with the hanging drops method at room temperature as well as at 16° C. Diffraction-quality crystals of H2OC1 were obtained (0.1 M HEPES pH 7.5, 0.2 M ammonium acetate plus 15% v/v isopropanol). X-ray diffraction data were collected on beamline 23-ID-D at the Advanced Photon Source, Argonne National Laboratory and analysed as described earlier. The massiveness of this structure prevents typical small-molecule X-ray crystallography analysis in detail.

### X-Ray Crystallography

For crystallization experiments, a lyophilized powder of H2OC1 was dissolved in double distilled water to a final concentration of 10 mg/ml. Crystallization trials were performed using sparse-matrix screening kits (Cation suite (Nextal) and Proplex (Molecular Dimensions)) in standard 96-well sitting-drops. Crystals obtained by this method were then optimized in 24-well plates with hanging drops typically composed of 0.5 μL foldamer solution and 0.5 μL crystallization reagent. Crystallization experiments were performed at room temperature as well as at 16C°. Diffraction quality crystals of H2OC1 were obtained from a crystallization reagent composed of 0.1 M HEPES pH 7.5, 0.2 M ammonium acetate plus 15% v/v isopropanol within three days at room temperature. Before data collection, crystals were soaked in the crystallization solution supplemented with 25% glycerol as a cryo-protectant and frozen in liquid nitrogen. X-ray diffraction data were collected on beamline 23-ID-D at the Advanced Photon Source, Argonne National Laboratory. Diffraction data were integrated and scaled using XDS7 and CCP49 to a final resolution of 1.2 Å. The structure was solved by molecular replacement using the crystal structure of H2′ as a search model using Phaser8 from the CCP4 suite. Geometric restraints were generated using PRODRG with model building and restrained refinement performed in Coot and Refmac5, respectively. B-factors were refined isotropically for water molecules and anisotropically for all other non-solvent atoms. Data collection and refinement statistics can be found in Table 3. The structure has been deposited in the CCDC with accession code 2211250.

### All-Atom MD Simulations

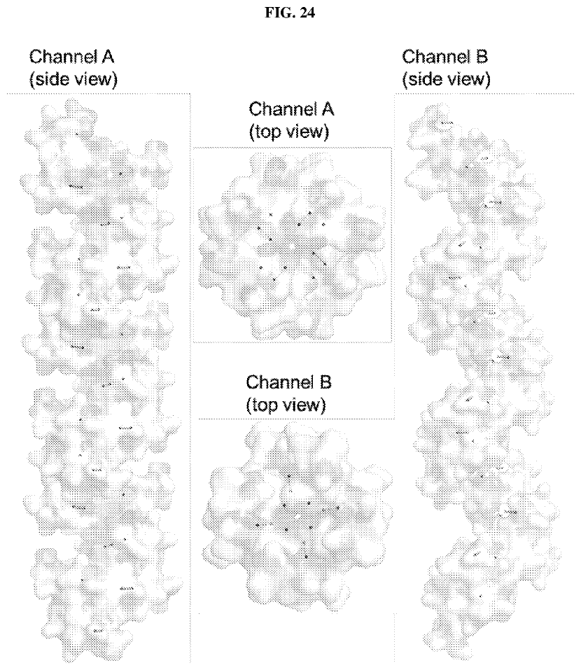

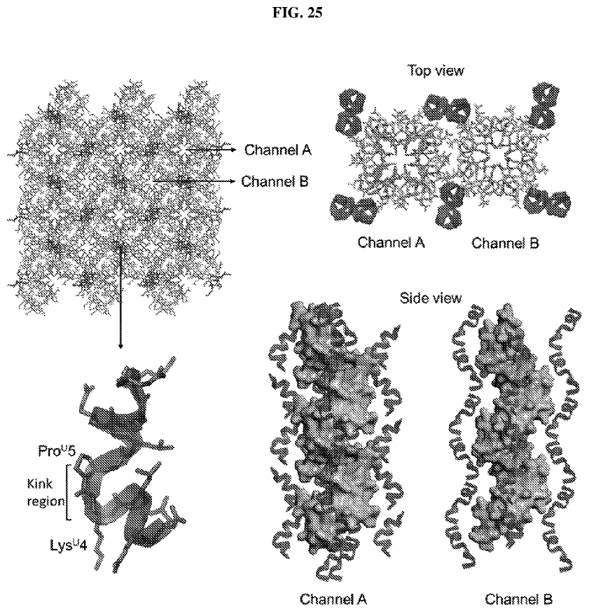

All-atom simulations were performed using the GROMACS 2018.3 simulation package utilizing the CHARMM36m force field with the TIP3P water model. The experimental structure of suprahelical H2OC1 oligourea channel composed of 8 helical monomers and 16 kinked H2OC1 helices was extracted from FIG. 24. Topologies were generated using CHARMM-GUI ligand reader and modeler. According to experimental procedures, N-terminus was acetylated (CH₃CO—) while C-terminus was amidated (—CONH₂) with all residues in a charged state at neutral pH. Two systems were built: i) 8 H2OC1 monomeric oligourea peptides with 16 kinked H2OC1 helices and ii) 8 H2OC1 monomeric oligourea peptides alone as a control. Both systems were minimized in vacuum using steepest descents algorithm for 5,000 steps. A symmetrical lipid bilayer composition corresponded to 1-palmitoyl-2-oleoyl-sn-glycero-3-phosphocholine (POPC) and 1-palmitoyl-2-oleoyl-snglycero-3-phospho-L-serine (POPS) in 4:1 lipid ratio respectively. The model bilayer was generated using CHARMM-GUI membrane builder. The box size was about 10×10×12 nm³. Subsequently, either i) or ii) construct was placed in the middle of the membrane. Any lipid within 0.3 nm of the channel were removed ensuring no lipids are inside of the channel. Approximately 30,000 TIP3P water molecules were added to the box and 150 mM NaCl salt was added to the box on top of neutralizing overall system charge. The energy minimization was performed using steepest descent minimization algorithm with a 0.1 energy step size. The system was equilibrated in the NVT and NPT ensemble for 200 ns with position restraints applied to helical H2OC1 peptides backbone atoms and a force constant of 1000 KJ mol⁻¹ nm⁻². Unrestrained production run was set to 600 ns in the NPT ensemble. A temperature of 310 K was maintained using the velocity rescaling thermostat with additional stochastic term using a time constant of 1 ps. Pressure was maintained semi-isotropically at 1 atm using Parrinello-Rahman barostat and a time constant of 5 ps. All bonds which involved hydrogens were constrained using the LINCS. Equations of motion were integrated using leap-frog algorithm with a time step of 2 fs. Long-range electrostatic interactions were described using the particle mesh Ewald method. The short-range electrostatic cut-off used was 1.2 nm and the shortrange van der Waals cut-off was also 1.2 nm. Periodic boundaries conditions were applied in all directions. Simulations were performed on an in-house Linux cluster composed of 8 nodes containing 2 GPUs (Nvidia Geforce RTX 2080 Ti) and 24 CPUs (Intel® Xeon® Gold 5118 CPU @ 2.3 GHZ). All simulations snapshots as well as averaged solvent density of each channel were performed using VMD. Averaged radius profile, number of water molecules or ions in the channel as well as permeation length were calculated using Channel Annotation Package (CHAP) tool. Root mean square deviation (RMSD) was calculated for alpha carbon atoms of 8 helical oligourea monomers alone.

### Solid-State NMR

For solid-state NMR experiments, liposome samples were prepared. Lipids (DMPC-d54 and POPS (4/1 molar ratio, 10 mg total lipids) were mixed and dissolved in CHCl₃. H2OC1 and H2OC2 were dissolved in CHCl₃/methanol (2:1 volume) and added to the lipid mixture at a ratio of 1/20 (molecule/lipid molar ratio). A control sample, only constituted by lipids, was also prepared. The solvent was evaporated under a stream of compressed air. The residual lipid film was dispersed in 1 ml of milliQ-filtered water and freeze-dried overnight. The resulting powder was suspended into 100 μL of deuterium-depleted water to obtain a hydration level of about 90%. After shaking into a vortex mixer, samples were frozen in liquid nitrogen for few seconds, heated at 45° C. for 10 minutes in a water bath and shaken again for better sample homogeneity; this freeze-thaw-shaking cycle was repeated 3 times and the resulting milky dispersion transferred into a 4 mm diameter Zirconium rotor of 80 μL (Cortecnet, Les Ulis, France). Spectral moments First moments were calculated using a homemade routine, NMRdepacker (Buchoux S., unpublished). Orientational order parameters (SCD) were calculated for each temperature by using a simulation program for wide line spectra developed in FORTRAN code by Erick Dufourc and implemented in a user-friendly graphical interface (Microsoft.NET) for Windows platforms by Arnaud Grélard. For ²H static wide-line solid-state NMR experiments, a quadrupolar spin-echo sequence was applied at a 2H frequency of 76.8 MHz on a 500 MHz (11.7 T) Bruker Avance III NMR spectrometer, with a 90° pulse of 3.5 μs, an echo delay of 50 μs, a recycle delay of 2 seconds, a spectral width of 500 kHz and 256 scans for each temperature. Spectra were acquired at different temperatures, ranging from 273K to 318K. The temperature of the sample was stabilized for 20 minutes prior to the acquisition.

For ³¹P static wide-line solid-state NMR, a Hahn-echo sequence was applied at a 31P frequency of 161.9 MHz on a 400 MHz (9.4 T) Bruker Avance III HD NMR spectrometer, with a 90° pulse of 8 μs, an echo delay of 40 μs, a recycle delay of 5 seconds, a spectral width of 400 ppm and 512 scans for each temperature. Spectra were acquired at different temperatures, ranging from 273K to 318K. The temperature of the sample was stabilized for 20 minutes prior to the acquisition.

### Measurements of Water Permeability at pH 6.4

Liposomes were prepared using a phosphatidylcholine (PC) and phosphatidylserine (PS) (phosphatidylcholine, Avanti Polar lipids). A PC/PS mixture with a molar ratio of 4/1 was dissolved in chloroform/methanol mixture (v/v=1/1). The solvent was removed under vacuum and then rehydrated with PBS buffer (10 mM, pH=6.4) for 40 minutes. After hydration, the suspension was submitted to 5-10 freeze-thaw cycles (liquid nitrogen, water at 25° C.).

Monodisperse unilamellar vesicles were obtained after extruding through 100 nm track-etched filters (Whatman, UK) for 21 times and diluted with HEPES buffer solution to give 11 mM lipid stock solution (considering all the lipids have been incorporated). The average radius of the vesicles was determined by using Zetasizer Nano (Malvern) dynamic light scattering experiment. 10 μL of 1 mM of compound was injected in the corresponding hypertonic osmolyte (which contains 100 μL of 11 mM lipid vesicles) to get a 5 μM final concentration in 2 mL total volume. Two times at least of repeated experiments were carried out to obtain the average permeability.

The stop-flow light scattering experiments were performed on a stopped-flow instrument (SFM3000+MOS450. Bio-Logic SAS, Claix, France) and recorded at a wavelength of 345 nm, under 600 mM sucrose as osmolytes (Δosm=600 mOsmol/kg respectively). The water permeability tests were conducted on a stopped-flow instrument (SFM3000+MOS450, Bio-Logic SAS, Claix, France). The abrupt change of the vesicle size under osmotic pressure leads to variation in the light scattering at 90° according to the Rayleigh-Gans theory applied to this system and could be fitted in the form of the sum of two exponential function

$$( y = at + b + , \begin{matrix}N = 2 \\ i = 1\end{matrix} {c}_{i} {e}^{- {k}_{i} t} ) .$$

by using Biokine software. The osmotic permeability (Pf) was calculated by following the equation:

$$Pf = k / [ ( S / {V}_{0} ) \times Vw \times Δ osm ] ,$$

where k is the exponential coefficient of the change in the light scattering; S and V₀ are the initial surface area and volume of the vesicles, respectively; Vw is the molar volume of water, and Δosm is the osmolarity difference.

The water transport ability of H2OC1 and H2OC2 was evaluated by stopped-flow assay using PC/PS (4:1) lipid vesicles at pH 6.4 (10 mM PBS). As shown in FIG. 1, under the hypertonic condition driven by sucrose osmolyte, the net permeabilities were showing a decreasing trend with the increasing concentration of sucrose. H2OC1 showed a slightly higher water permeabilities than H2OC2 at high osmotic pressure.

### Single Channel Current Measurement Using Planar Lipid Bilayer Workstation

### For Measuring Proton Transport in the Unit of pS

A mixture of phosphatidylcholine (PC) and phosphatidylserine (PS) (PC: PS=4:1), or DOPC (1,2-dioleoyl-sn-glycero-3-phosphocholine, Avanti Polar lipids, 25 mg/ml in CHCl3) was dried under N2 gas for 1 hour and then re-dissolved in decane. Salt bridges (KCl/Agar) were placed in the chambers filled with 0.1 M HCl solution, attaching electrodes (Ag/AgCl) which were placed in KCl solution (1 M). Planar lipid bilayers were formed by brushing 0.2 μL of lipid containing n-decane solution around the aperture, and a stable bilayer were obtained with a capacitance value ranging from 80 to 150 pF without applying any voltage. Single channel current traces were tested repeatedly for capacitance and resistance at different voltage. The obtained data was collected by ClampFit 10.3.1.5, and then analysed in Origin, fitting using a linear equation of “y=a+bx” where slope b is the conductance value (γ), unit: nS.

### For Measuring Ion Transport in the Unit of pS

A solution of DOPC (1,2-dioleoyl-sn-glycero-3-phosphocholine, Avanti Polar lipids, 25 mg/ml in CHCl3) was dried under N₂ gas for 1 hour and then redissolved in n-decane. Salt bridges (KCl/Agar) were placed in the chambers filled with KCl buffer (1 M, 10 mM HEPES, 10 mM Tris), attaching electrodes (Ag/AgCl) which were placed in KCl solution (1 M). Planar lipid bilayers were formed by brushing 0.2 μL of lipid-containing n-decane solution around the aperture, and a stable bilayer were obtained with a capacitance value ranging from 80 to 150 pF without applying any voltage. Single channel current traces were tested repeatedly for capacitance and resistance at different voltage. The obtained data was collected by ClampFit 10.3.1.5, and then analysed in Origin, fitting using a linear equation of “y=a+bx” where slope b is the conductance value (γ), unit: nS.

For the measurement of ion selectivity ratio (PNa+/PK+): KCl buffer (1 M, 10 mM HEPES, 10 mM Tris) was used in the cis chamber and the trans chamber was still filled in NaCl buffer (1 M, 10 mM HEPES, 10 mM Tris). The obtained data was fitted with the following Goldman-Hodgkin-Katz equation for calculation: εrev=RT/F×In (PNa+/PK+), R=universal gas constant (8.314 J·K⁻¹·mol⁻¹), T=300 K, F=Faraday's constant (96485 C·mol⁻¹), P is the permeability of sample for ions. Erev Was determined by fitting using a linear equation of “y=a+bx”, where-intercept/slope (−a/b) is the reverse potential value (εrev).

### All-Atom MD Simulations

All-atom simulations were performed using the GROMACS 2018.3 simulation package utilizing the CHARMM36m force field with the TIP3P water model. The experimental structure of suprahelical H2OC1 oligourea channel composed of 8 helical monomers and 16 kinked H2OC1 helices was extracted from (FIG. 25). Topologies were generated using CHARMM-GUI ligand reader and modeler.24 According to experimental procedures, the N-terminus was acetylated (CH3CO—) while the C-terminus was amidated (—CONH2) with all residues in a charged state at neutral pH. Two systems were built: i) 8 H2OCl monomeric oligourea peptides with 16 kinked H2OCl helices and ii) 8 H2OC1 monomeric oligourea peptides alone as a control. Both systems were minimized in vacuum using steepest descents algorithm for 5,000 steps. A symmetrical lipid bilayer composition corresponded to 1-palmitoyl-2-oleoyl-sn-glycero-3-phosphocholine (POPC) and 1-palmitoyl-2-oleoyl-sn-glycero-3-phospho-L-serine (POPS) in 4:1 lipid ratio, respectively. The model bilayer was generated using CHARMM-GUI membrane builder. The box size was ~10×10×12 nm³. Subsequently, either i) or ii) construct was placed in the middle of the membrane. Any lipid within 0.3 nm of the channel were removed ensuring no lipids are inside of the channel. Approximately 30,000 TIP3P water molecules were added to the box and 150 mM NaCl salt was added to the box on top of neutralizing overall system charge. The energy minimization was performed using steepest descent minimization algorithm with a 0.1 energy step size. The system was equilibrated in the NVT and NPT ensemble for 200 ns with position restraints applied to helical H2OC1 peptides backbone atoms and a force constant of 1000 KJ mol⁻¹ nm⁻². Unrestrained production run was set to 600 ns in the NPT ensemble. A temperature of 310 K was maintained using the velocity rescaling thermostat with additional stochastic term using a time constant of 1 ps. Pressure was maintained semi-isotropically at 1 atm using Parrinello-Rahman barostat and a time constant of 5 ps. All bonds which involved hydrogens were constrained using the LINCS. Equations of motion were integrated using leap-frog algorithm with a time step of 2 fs. Long-range electrostatic interactions were described using the particle mesh Ewald method. The short-range electrostatic cut-off used was 1.2 nm and the short-range van der Waals cut-off was also 1.2 nm. Periodic boundaries conditions were applied in all directions.

Simulations were performed on an in-house Linux cluster composed of 8 nodes containing 2 GPUs (Nvidia Geforce RTX 2080 Ti) and 24 CPUs (Intel® Xeon® Gold 5118 CPU @ 2.3 GHZ). All simulations snapshots as well as averaged solvent density of each channel were performed using VMD.23 Averaged radius profile, number of water molecules or ions in the channel as well as permeation length were calculated using Channel Annotation Package (CHAP) tool.25 Root mean square deviation (RMSD) was calculated for alpha carbon atoms of 8 helical oligourea monomers alone.

### Test Membranes

Methods used for the test membrane study are, for example, as follows: A polysulfone (PSF) membrane substrate was prepared using a pilot-scale casting machine according to methods known in the art. To incorporate oligourea foldamers that act as artificial water channels (AWCs) into the polyamide selective layer of membranes, a spray-assisted interfacial polymerization (IP) technique was used. In brief, a substrate of 20×13 cm² was soaked in a 2% (w/v) m-phenylenediamine (MPD) solution for 2 minutes and the excess MPD was removed using an air knife. An automated spraying machine was used to evenly distribute channel-containing liposomes on the substrate surface before being immersed into TMC (0.1 w/v %) solution.

The membrane separation performance was evaluated using a high-pressure cross-flow reverse osmosis setup equipped with four units of membrane cells (Sterli-tech CF042D, effective area of 42 cm²). To achieve stable water flux, each membrane coupon was compacted using ultrapure water at 50 bar for 1 hour. NaCl was then added to the feed tank to achieve 35,000 ppm concentration to measure rejection performance at cross-flow velocity of 10 cm/s and temperature of 23° C. For each type of membrane, four independent coupons were tested to obtain the deviation in membrane performance. The membrane pure water permeability coefficient (A) and solute rejection (R) were determined using Eqns 1 and 2:

$$A = \frac{{J}_{w}}{Δ P} \qquad ( Eqn 1 )$$

$$R = 1 - \frac{{C}_{p}}{{C}_{f}} \qquad ( Eqn 2 )$$

where Jw is the pure water flux measured using ultrapure water feed; ΔP is the transmembrane pressure; Cf and Cp are the solute concentrations in the feed and permeate, respectively.

SEQUENCE LISTING

| SEQ | | |
|---|---|---|
| ID | Sequence | |
| NO: | (shown C to N terminal) | Description |
| 1 | Ac-L^{U}E^{U}L^{U}K^{U}P^{U}L^{U}E^{U}L^{U}K^{U}A^{U}-NH₂ | H20C1 |
| 2 | Ac-L^{U}E^{U}L^{U}K^{U}A^{U}L^{U}E^{U}L^{U}K^{U}A^{U}-NH₂ | H20C2 |
| 3 | Ac-L^{U}N^{U}L^{U}K^{U}P^{U}L^{U}N^{U}L^{U}K^{U}A^{U}-NH₂ | H20C3 |
| 4 | Ac-L^{U}E^{U}L^{U}K^{U}F^{U}L^{U}E^{U}L^{U}K^{U}F^{U}-NH₂ | H20C4 |

1. (canceled)

2. (canceled)

3. (canceled)

4. (canceled)

5. (canceled)

6. A compound comprising oligourea foldamers, wherein the oligourea foldamers comprise one or more sequences selected from the group consisting of
SEQ ID NO: 1
Ac-L^{U}E^{U}L^{U}K^{U}P^{U}L^{U}E^{U}L^{U}K^{U}A^{U}-NH₂
and
SEQ ID NO: 2
Ac-L^{U}E^{U}L^{U}K^{U}A^{U}L^{U}E^{U}L^{U}K^{U}A^{U}-NH_{2.}

7. The compound according to claim 6, wherein the oligourea foldamers self-assemble into a three-dimensional nanostructure under aqueous conditions.

8. The compound according to claim 7, wherein the three-dimensional nanostructure is a helix or a pore.

9. The compound according to claim 8, wherein the three-dimensional nanostructure has a pore size with an internal diameter of between 4.5 Å to 6.5 Å.

10. A permeable membrane comprising the compound of claim 6.

11. A method of purifying water, the method comprising allowing water to pass through a filtration device comprising the permeable membrane according to claim 10.

12. The method according to claim 11, wherein the permeable membrane is water permeable and rejects 99% of salt present.

13. The compound of claim 6, wherein the sequence is SEQ ID NO: 1.

14. The compound of claim 6, wherein the sequence is SEQ ID NO: 2.

15. The compound of claim 6, wherein the oligourea foldamer is water permeable.

16. The compound of claim 6, wherein the oligourea foldamer rejects 99% of ions.
